(19) United States
(12) Patent Application Publication
(10) Pub. No.: US 2006/0276342 A1
(43) Pub. Date: Dec. 7, 2006

(54) Herbicidal compositions

(75) Inventors: Hansjorg Krahmer, Hofheim (DE); Martin Hills, Idstein (DE); Klaus Trabold, Heidelberg (DE); Erwin Hacker, Hochheim (DE)

Correspondence Address: STERNE, KESSLER, GOLDSTEIN & FOX PLLC, 1100 NEW YORK AVENUE, N.W., WASHINGTON, DC, 20005, US

(73) Assignee: BAYER CROPSCIENCE GMBH, Frankfurt (DE)

(21) Appl. No.: 11/445,443

(22) Filed: Jun. 2, 2006

(30) Foreign Application Priority Data
Jun. 4, 2005 (EP) 05012119.3

(51) Int. Cl. A01N 43/72

(52) U.S. Cl. 504/223

(57) ABSTRACT

The present invention relates to herbicidal compositions comprising a) one or more herbicidally active compounds from the group of the dioxazinepyridylsulfonylureas, and b) one or more auxiliaries from the group of the fatty esters, fertilizers and surfactants.

The invention relates to the technical field of the crop protection compositions; in particular, the invention relates to herbicidal compositions having a synergistic content of dioxazinepyridylsulfonylureas and auxiliaries from the group of the fatty esters, fertilizers and wetting agents. The herbicidal compositions are highly suitable for controlling harmful plants, for example in crop plants.

The use of sulfonylureas as active component of crop protection compositions is known (for example EP-A-007 687, EP-A-030 138). It is also known to combine sulfonylureas such as nicosulfuron (Accent®) with vegetable oils (for example CPR/T & OR 1999 Adjuvant Reference Supplement—C&P Press 1.998, p. 55/56).

It was an object of the present invention to provide herbicidal compositions having high herbicidal action and also high compatibility with crop plants.

Surprisingly, it has now been found that this object is achieved by herbicidal compositions comprising specific sulfonylureas in combination with certain auxiliaries in a synergistic amount.

Accordingly, the present invention relates to a herbicidal composition comprising a synergistically effective amount of

a) one or more herbicidally active compounds from the group of the dioxazinepyridylsulfonylureas, and

b) one or more auxiliaries from the group of the fatty esters, fertilizers and surfactants.

Preferred dioxazinepyridylsulfonylureas a) are those of the formula (I) and/or salts thereof 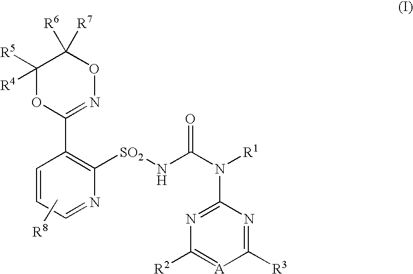
in which
A is nitrogen or a CR¹¹ grouping,
   where
   R¹¹ is hydrogen, alkyl, halogen or haloalkyl,
R¹ is hydrogen or an optionally substituted radical from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,

where in the radicals mentioned above the alkyl and alkylene groups may each contain 1 to 6 carbon atoms, the alkenyl and alkynyl groups may each contain 2 to 6 carbon atoms, the cycloalkyl groups may each contain 3 to 6 carbon atoms and the aryl groups may each contain 6 or 10 carbon atoms.

Dioxazinepyridylsulfonylureas, such as the compounds of the formula (I) and salts thereof, are known, as is their preparation, for example from U.S. Pat. No. 5,476,936, the contents of which is part of the present description by way of reference. However, the prior art does not disclose that these compounds are highly suitable as combination partners in preferably synergistic mixtures with auxiliaries from the group of the fatty esters, fertilizers and wetting agents.

Preference is given to compounds of the formula (I) and/or salts thereof in which
A is nitrogen or a CH grouping,
R¹ is hydrogen or an optionally halogen-substituted radical from the group consisting of alkyl, alkoxy, alkoxyalkyl, alkenyl and alkynyl having in each case up to 3 carbon atoms,
R² is hydrogen, halogen or is in each case optionally halogen-substituted alkyl, alkoxy, alkylthio, alkylamino or dialkylamino having in each case 1 to 3 carbon atoms in the alkyl radicals,
R³ is hydrogen, halogen or is in each case optionally halogen-substituted alkyl, alkoxy, alkylthio, alkylamino or dialkylamino having in each case 1 to 3 carbon atoms in the alkyl radicals,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals.

Preference is furthermore given to salts obtained by customary processes from compounds of the formula (I) and bases, such as, for example, sodium hydroxide, potassium hydroxide or calcium hydroxide, sodium hydride, potassium hydride or calcium hydride, sodium amide, potassium amide or calcium amide and sodium carbonate, potassium carbonate or calcium carbonate, sodium C₁-C₄-alkoxides or potassium C₁-C₄-alkoxides, ammonia, C₁-C₄-alkylamines, di-(C₁-C₄-alkyl)amines or tri-(C₁ -C₄-alkyl)amines.

Specially preferred are compounds of the formula (I) and/or salts thereof, in which
A is nitrogen or a CH grouping,
R¹ is hydrogen, methyl, ethyl, methoxy, methoxymethyl or ethoxy,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ independently of one another are hydrogen, fluorine, chlorine, cyano, or are in each case optionally chlorine- or fluorine-substituted methyl, methylthio, methylsulfinyl, methylsulfonyl, methoxycarbonyl or ethoxycarbonyl, preferably hydrogen,
R⁸ is hydrogen, fluorine, chlorine, bromine, cyano or is in each case optionally chlorine- or fluorine-substituted methyl, methoxy, ethoxy, methylthio, ethylthio, methylsulfinyl, ethylsulfinyl, methylsulfonyl, ethylsulfonyl, methyl- or dimethylamino, preferably hydrogen.

Particular preference is given to compounds of the formula (I) and/or salts thereof, in particular their alkali metal salts,

in which

A is nitrogen,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ are hydrogen,
R⁸ is hydrogen.

Particular preference is also given to compounds of the formula (I) and/or salts thereof, in particular their alkali metal salts,

in which

A is a CH grouping,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ are hydrogen,
R⁸ is hydrogen.

The general or preferred radical definitions given above can be combined with one another as desired, i.e. including combinations between the given preferred ranges.

The hydrocarbon radicals mentioned in the radical definitions, such as alkyl, alkenyl or alkynyl, can be straight-chain or branched even if this is not explicitly stated, including in combination with heteroatoms, such as in alkoxy, alkylthio, haloalkyl or alkylamino.

The dioxazinepyridylsulfonylureas a), for example those of the formula (I), can be present as a neutral compound or as salts, for example as metal salts, such as alkali metal (for example Na, K) salts or as alkaline earth metal (for example Ca, Mg) salts or as ammonium salts or amine salts. Such salts are obtained in a simple manner by customary methods for forming salts, for example by dissolving or dispersing a pyridylsulfonylurea, for example of the formula (I), in a suitable diluent, such as, for example, methylene chloride, acetone, tert-butyl methyl ether or toluene, and adding a suitable base. The salts can then—if appropriate after prolonged stirring—be isolated by concentration or filtration with suction.

Dioxazinepyridylsulfonylureas a) preferably present according to the invention are listed in table 1 below, where the following abbreviations are used:

m.p.:=melting point

⁽⁺⁾=the indicated melting point (m.p.) refers to the respective sodium salt, i.e. the corresponding compound in which the hydrogen of the —SO₂—NH— group is replaced by sodium.

TABLE 1
Examples of compounds of the formula (I) where
R⁴ = R⁵ = R⁶ = R⁷ = R⁸ = H:

| | | | | | m.p. |
|---|---|---|---|---|---|
| Ex. No. | R¹ | A | R² | R³ | (° C.) |
| I-1 | H | CH | OCH₃ | OC₂H₅ | 154 |
| I-2 | H | CH | OCH₃ | CH₃ | |
| I-3 | H | CH | OHC₃ | CH₃ | 180-181⁽⁺⁾ |
| I-4 | H | CH | OCH₃ | C₂H₅ | |
| I-5 | H | CH | OCH₃ | CF₃ | |
| I-6 | H | CH | OCH₃ | OCF₂H | |
| I-7 | H | CH | OCH₃ | NHCH₃ | |
| I-8 | H | CH | OCH₃ | N(CH₃)₂ | 199.5 |
| I-9 | H | CH | OCH₃ | Cl | 110-111 |
| I-10 | H | CH | OCH₃ | Cl | 175-178⁽⁺⁾ |
| I-11 | H | CH | OCH₃ | OCH₃ | 167-168 |
| I-12 | H | CH | OCH₃ | OCH₃ | 171-172⁽⁺⁾ |
| I-13 | H | CH | OC₂H₅ | OC₂H₅ | |
| I-14 | H | CH | OC₂H₅ | OC₂H₅ | 152-154⁽⁺⁾ |
| I-15 | H | CH | OC₂H₅ | CH₃ | |
| I-16 | H | CH | OC₂H₅ | C₂H₅ | |
| I-17 | H | CH | OC₂H₅ | CF₃ | |
| I-18 | H | CH | OC₂H₅ | OCF₂H | |
| I-19 | H | CH | OC₂H₅ | NHCH₃ | |
| I-20 | H | CH | OC₂H₅ | N(CH₃)₂ | |
| I-21 | H | CH | OC₂H₅ | Cl | 158-159 |
| I-22 | H | CH | OC₂H₅ | Cl | 213⁽⁺⁾ |
| I-23 | H | CH | CH₃ | CH₃ | 153 |
| I-24 | H | CH | CH₃ | C₂H₅ | |
| I-25 | H | CH | CH₃ | CF₃ | |
| I-26 | H | CH | CH₃ | OCF₂H | |
| I-27 | H | CH | CH₃ | NHCH₃ | |
| I-28 | H | CH | CH₃ | N(CH₃)₂ | |
| I-29 | H | CH | CH₃ | Cl | 108-109 |
| I-30 | H | CH | CH₃ | Cl | >300⁽⁺⁾ |
| I-31 | H | CH | C₂H₅ | C₂H₅ | |
| I-32 | H | CH | C₂H₅ | CF₃ | |
| I-33 | H | CH | C₂H₅ | OCF₂H | |
| I-34 | H | CH | C₂H₅ | NHCH₃ | |
| I-35 | H | CH | C₂H₅ | Cl | |
| I-36 | H | CH | CF₃ | CF₃ | |
| I-37 | H | CH | CF₃ | OCF₂H | |
| I-38 | H | CH | CF₃ | NHCH₃ | |
| I-39 | H | CH | CF₃ | N(CH₃)₂ | |
| I-40 | H | CH | CF₃ | Cl | |
| I-41 | H | CH | OCF₂H | OCF₂H | |
| I-42 | H | CH | OCF₂H | NHCH₃ | |
| I-43 | H | CH | OCF₂H | N(CH₃)₂ | |
| I-44 | H | CH | OCF₂H | Cl | |
| I-45 | H | CH | NHCH₃ | NHCH₃ | |
| I-46 | H | CH | NHCH₃ | N(CH₃)₂ | |
| I-47 | H | CH | NHCH₃ | Cl | |
| I-48 | H | CH | N(CH₃)₂ | N(CH₃)₂ | |
| I-49 | H | CH | N(CH₃)₂ | Cl | |
| I-50 | H | CH | Cl | Cl | |
| I-51 | H | N | OCH₃ | OCH₃ | 255 |
| I-52 | H | N | OCH₃ | OCH₃ | 159-162⁽⁺⁾ |
| I-53 | H | N | OCH₃ | OC₂H₅ | |
| I-54 | H | N | OCH₃ | CH₃ | |
| I-55 | H | N | OCH₃ | C₂H₅ | |
| I-56 | H | N | OCH₃ | CF₃ | |
| I-57 | H | N | OCH₃ | OCF₂H | |
| I-58 | H | N | OCH₃ | NHCH₃ | |
| I-59 | H | N | OCH₃ | N(CH₃)₂ | |
| I-60 | H | N | OCH₃ | N(CH₃)₂ | 156⁽⁺⁾ |
| I-61 | H | N | OCH₃ | Cl | |
| I-62 | H | N | OC₂H₅ | OC₂H₅ | |
| I-63 | H | N | OC₂H₅ | CH₃ | |
| I-64 | H | N | OC₂H₅ | C₂H₅ | |
| I-65 | H | N | OC₂H₅ | CF₃ | |
| I-66 | H | N | OC₂H₅ | OCF₂H | |
| I-67 | H | N | OC₂H₅ | NHCH₃ | |
| I-68 | H | N | OC₂H₅ | N(CH₃)₂ | |
| I-69 | H | N | OC₂H₅ | Cl | |
| I-70 | H | N | OC₂H₅ | Cl | 213⁽⁺⁾ |
| I-71 | H | N | CH₃ | CH₃ | |
| I-72 | H | N | CH₃ | C₂H₅ | |
| I-73 | H | N | CH₃ | CF₃ | |
| I-74 | H | N | CH₃ | OCF₂H | |
| I-75 | H | N | CH₃ | NHCH₃ | |
| I-76 | H | N | CH₃ | N(CH₃)₂ | |
| I-77 | H | N | CH₃ | Cl | |
| I-78 | H | N | C₂H₅ | C₂H₅ | |
| I-79 | H | N | C₂H₅ | CF₃ | |
| I-80 | H | N | C₂H₅ | OCF₂H | |
| I-81 | H | N | C₂H₅ | NHCH₃ | |
| I-82 | H | N | C₂H₅ | Cl | |
| I-83 | H | N | CF₃ | CF₃ | |
| I-84 | H | N | CF₃ | OCF₂H | |
| I-85 | H | N | CF₃ | NHCH₃ | |
| I-86 | H | N | CF₃ | N(CH₃)₂ | |
| I-87 | H | N | CF₃ | Cl | |
| I-88 | H | N | OCF₂H | OCF₂H | |
| I-89 | H | N | OCF₂H | NHCH₃ | |
| I-90 | H | N | OCF₂H | N(CH₃)₂ | |
| I-91 | H | N | OCF₂H | Cl | |
| I-92 | H | N | NHCH₃ | NHCH₃ | |
| I-93 | H | N | NHCH₃ | N(CH₃)₂ | |
| I-94 | H | N | NHCH₃ | Cl | |
| I-95 | H | N | N(CH₃)₂ | N(CH₃)₂ | |
| I-96 | H | N | N(CH₃)₂ | Cl | |
| I-97 | H | N | Cl | Cl | |
| I-98 | CH₃ | N | OCH₃ | OCH₃ | |
| I-99 | CH₃ | N | OCH₃ | OC₂H₅ | |
| I-100 | CH₃ | N | OCH₃ | CH₃ | |
| I-101 | CH₃ | N | OCH₃ | C₂H₅ | |
| I-102 | CH₃ | N | OCH₃ | CF₃ | |
| I-103 | CH₃ | N | OCH₃ | OCF₂H | |
| I-104 | CH₃ | N | OCH₃ | NHCH₃ | |
| I-105 | CH₃ | N | OCH₃ | N(CH₃)₂ | |
| I-106 | CH₃ | N | OCH₃ | Cl | |
| I-107 | CH₃ | N | OC₂H₅ | OC₂H₅ | |
| I-108 | CH₃ | N | OC₂H₅ | CH₃ | |
| I-109 | CH₃ | N | OC₂H₅ | C₂H₅ | |
| I-110 | CH₃ | N | OC₂H₅ | CF₃ | |
| I-111 | CH₃ | N | OC₂H₅ | OCF₂H | |
| I-112 | CH₃ | N | OC₂H₅ | NHCH₃ | |
| I-113 | CH₃ | N | OC₂H₅ | N(CH₃)₂ | |
| I-114 | CH₃ | N | OC₂H₅ | Cl | |
| I-115 | CH₃ | N | CH₃ | CH₃ | |
| I-116 | CH₃ | N | CH₃ | C₂H₅ | |
| I-117 | CH₃ | N | CH₃ | CF₃ | |
| I-118 | CH₃ | N | CH₃ | OCF₂H | |
| I-119 | CH₃ | N | CH₃ | NHCH₃ | |
| I-120 | CH₃ | N | CH₃ | N(CH₃)₂ | |
| I-121 | CH₃ | N | CH₃ | Cl | |
| I-122 | CH₃ | N | C₂H₅ | C₂H₅ | |
| I-123 | CH₃ | N | C₂H₅ | CF₃ | |
| I-124 | CH₃ | N | C₂H₅ | OCF₂H | |
| I-125 | CH₃ | N | C₂H₅ | NHCH₃ | |
| I-126 | CH₃ | N | C₂H₅ | Cl | |
| I-127 | CH₃ | N | CF₃ | CF₃ | |
| I-128 | CH₃ | N | CF₃ | OCF₂H | |
| I-129 | CH₃ | N | CF₃ | NHCH₃ | |
| I-130 | CH₃ | N | CF₃ | N(CH₃)₂ | |
| I-131 | CH₃ | N | CF₃ | Cl | |
| I-132 | CH₃ | N | OCF₂H | OCF₂H | |
| I-133 | CH₃ | N | OCF₂H | NHCH₃ | |
| I-134 | CH₃ | N | OCF₂H | N(CH₃)₂ | |
| I-135 | CH₃ | N | OCF₂H | Cl | |
| I-136 | CH₃ | N | NHCH₃ | NHCH₃ | |
| I-137 | CH₃ | N | NHCH₃ | N(CH₃)₂ | |
| I-138 | CH₃ | N | NHCH₃ | Cl | |
| I-139 | CH₃ | N | N(CH₃)₂ | N(CH₃)₂ | |
| I-140 | CH₃ | N | N(CH₃)₂ | Cl | |
| I-141 | CH₃ | N | Cl | Cl | |
| I-142 | H | N | N(CH₃)₂ | OCH₂CF₃ | 158 |
| I-143 | H | CH | Cl | OCH₂CF₃ | 204-205 |
| I-144 | H | CH | Cl | OCH₂CF₃ | |
| I-145 | H | CH | Cl | OCH₂CF₃ | 207⁽⁺⁾ |

For the purpose of the present invention, the dioxazinepyridylsulfonylureas contained as component a) in the oil suspension concentrates according to the invention are in each case to be understood as meaning all use forms, such as acids, esters, salts and isomers, such as stereoisomers and optical isomers. Thus, in addition to neutral compounds, their salts for example with inorganic and/or organic counterions are in each case meant to be included. Thus, ureas are capable of forming salts, for example, in which the hydrogen of the —SO₂—NH group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in this description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids.

An acyl radical is preferably formyl or acyl from the group consisting of CO—R^{Z}, CS—R^{Z}, CO—OR^{Z}, CS—OR^{Z}, CS—SR^{Z}, SOR^{Z} and SO₂R^{Z}, where R^{Z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{Z} is aminocarbonyl or aminosulfonyl, where the two last-mentioned radicals are unsubstituted, N-monosubstituted or N,N-disubstituted, for example by substituents from the group consisting of alkyl and aryl.

Acyl is, for example, formyl, haloalkylcarbonyl, alkylcarbonyl, such as (C₁-C₄)-alkyl-carbonyl, phenylcarbonyl, where the phenyl ring may be substituted, or alkyloxy-carbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N-(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl. A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Optionally substituted phenyl is preferably phenyl-which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methyl-prop-2-en-1-yl, but-2-en-1-yl, but-3-en-1-yl, 1-methyl-but-3-en-1-yl and 1-methyl-but-2-en-1-yl; alkynyl is, for example, propargyl, but-2-yn-1-yl, but-3-yn-1-yl, 1-methyl-but-3-yn-1-yl.

Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl: haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

The herbicidally active compounds a) inhibit the enzyme acetolactate synthase (ALS) and thus the protein synthesis in plants. The application rate of the herbicides (a) may vary within a wide range, for example between 0.001 g and 500 g of a.i./ha (hereinbelow, a.i./ha means “active ingredient per hectare”=based on 100% pure active compound). On applications using application rates of from 0.01 g to 200 g of a.i./ha of the herbicidally active compound a), preferably the compounds I-1 to I-145, a relatively broad spectrum of harmful plants, for example of annual and perennial monocotyledonous or dicotyledonous weeds and also unwanted crop plants is controlled by the pre-emergence and the post-emergence method. In the herbicidal compositions according to the invention, the application rates are generally lower, for example in the range of from 0.001 g to 100 g of a.i./ha, preferably from 0.05 g to 50 g of a.i./ha, particularly preferably from 0.1 g to 9 g of a.i./ha.

As component b), the herbicidal compositions according to the invention comprise one or more auxiliaries from the group of the fatty esters, fertilizers and surfactants.

As fatty esters, the herbicidal compositions according to the invention may comprise, for example, fatty esters of natural origin, for example natural oils, such as animal oils or vegetable oils, or fatty esters of synthetic origin, for example the Edenor® series, for example Edenor®MEPa or Edenor®MESU, or the AGNIQUE®ME series or the AGNIQUE®AE series (Cognis), the SALIM®ME series (Salim), the Radia® series, for example Radia®30167 (Fina Chemicals), the Priolube® series, for example Priolube®1530 (Unichema), the STEPAN®C series (Stepan) or the WITCONOL®23 series (Witco). The fatty esters are preferably esters of C₁₀-C₂₂-, with preference C₁₂-C₂₀-, fatty acids. The C₁₀-C₂₂-fatty acids are, for example, esters of unsaturated or saturated C₁₀-C₂₂-fatty acids, in particular those having an even number of carbons, for example erucic acid, lauric acid, palmitic acid, and in particular C₁₈-fatty acids, such as stearic acid, oleic acid, linoleic acid or linolenic acid.

Examples of fatty esters such as C₁₀-C₂₂-fatty esters are glycerol and glycol esters of fatty acids such as C₁₀-C₂₂-fatty acids, or transesterification products thereof, for example fatty acid alkyl esters such as C₁₀-C₂₂-fatty acid C₁-C₂₀-alkyl esters, which can be obtained, for example, by transesterification of the abovementioned glycerol and glycol fatty acid esters such as C₁₀-C₂₂-fatty esters with C₁-C₂₀-alcohols (for example methanol, ethanol, propanol or butanol). The transesterification can be carried out by known methods as described, for example, in Römpp Chemie Lexikon, 9th edition, volume 2, page 1343, Thieme Verlag Stuttgart.

Preferred fatty acid alkyl esters such as C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol fatty esters such as C₁₀-C₂₂-fatty esters are the uniform or mixed glycol esters and glycerol esters of C₁₀-C₂₂-fatty acids, in particular of such fatty acids having an even number of carbon atoms, for example erucic acid, lauric acid, palmitic acid and in particular C₁₈-fatty acids such as stearic acid, oleic acid, linoleic acid or linolenic acid.

Animal oils b) present in the herbicidal compositions according to the invention are generally known and commercially available. For the purpose of the present invention, the term “animal oils” is to be understood as meaning, for example, oils of animal origin such as whale oil, cod-liver oil, musk oil or mink oil.

Fatty acid esters preferably present in the herbicidal compositions according to the invention are vegetable oils. These are generally known and commercially available. For the purpose of the present invention, the term “vegetable oils” is to be understood as meaning, for example, oils of oleaginous plant species, such as soy bean oil, rapeseed oil, corn oil, sunflower oil, cottonseed oil, linseed oil, coconut oil, palm oil, thistle oil, walnut oil, arachis oil, olive oil or castor oil, in particular rapeseed oil, where the vegetable oils also include their transesterification products, for example alkyl esters, such as rapeseed oil methyl ester or rapeseed oil ethyl ester.

The vegetable oils are preferably esters of C₁₀-C₂₂-, preferably C₁₂-C₂₀-fatty acids. The C₁₀-C₂₂-fatty esters are, for example, esters of unsaturated or saturated C₁₀-C₂₂-fatty acids having, in particular, an even number of carbon atoms, for example erucic acid, lauric acid, palmitic acid and, in particular, C₁₈-fatty acids such as stearic acid, oleic acid, linoleic acid or linolenic acid.

Examples of vegetable oils are C₁₀-C₂₂-fatty esters of glycerol or glycol with C₁₀-C₂₂-fatty acids, or C₁₀-C₂₂-fatty acid C₁-C₂₀-alkyl esters which can be obtained, for example, by transesterification of the glycerol or glycol C₁₀-C₂₂-fatty esters mentioned above with C₁-C₂₀-alcohols (for example methanol, ethanol, propanol or butanol). The transesterification can be carried out by known methods as described, for example, in Römpp Chemie Lexikon, 9th edition, volume 2, page 1343, Thieme Verlag Stuttgart.

The vegetable oils can be present in the compositions according to the invention for example in the form of commercially available vegetable oils, in particular rapeseed oils, such as rapeseed oil methyl ester, for example Phytorob®B (Novance, France, hereinbelow referred to as Phytorob B), Edenor® MESU (Cognis, Germany, hereinbelow referred to as Edenor) and the Agnique® ME series (Cognis, Germany, hereinbelow referred to as Agnique), the Priolube® series (Unichema, hereinbelow referred to as Priolube) or biodiesel or in the form of commercially available, vegetable-oil-containing formulation additives, in particular those based on rapeseed oils, such as rapeseed oil methyl esters, for example Hasten® (Victorian Chemical Company, Australia, hereinbelow referred to as Hasten, main ingredient: rapeseed oil methyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, main ingredient: rapeseed oil methyl ester) or Stefes Mero® (Stefes, Germany, hereinbelow referred to as Mero, main ingredient: rapeseed oil methyl ester).

Examples of synthetic fatty esters are, for example, those derived from fatty acids having an odd number of carbon atoms, such as, for example, C₁₁-C₂₁-fatty esters.

As fertilizers, the herbicidal compositions according to the invention may comprise, for example, urea or ammonium salts, preferably urea, ammonium sulfates, such as monoammonium sulfate or diammonium sulfate, ammonium nitrate, ammonium nitrate/calcium nitrate mixtures, ammonium nitrate/urea mixtures (AHL), ammonium thiosulfate, ammonium chloride, ammonium phosphates, such as monoammonium phosphate, diammonium phosphate or triammonium phosphate, calcium ammonium nitrate, ammonium carbonates such as monoammonium carbonate or diammonium carbonate, and mixtures thereof. Preferred fertilizers are ammonium sulfates, in particular diammonium sulfate, ammonium nitrate and ammonium nitrate/urea mixtures.

As surfactants, the herbicidal compositions according to the invention may comprise, for example, nonionic or ionic, for example cationic or anionic, surfactants, preferably nonionic surfactants.

Suitable nonionic surfactants are, for example:
1) polyalkoxylated, preferably polyethoxylated, saturated and unsaturated aliphatic alcohols,
   having 8 to 24 carbon atoms in the alkyl radical, which is derived from the corresponding fatty acids or from petrochemical products, and
   having 1 to 100, preferably 2 to 50, ethylene oxide units (EO), it being possible for the free hydroxyl group to be alkoxylated,
   which are commercially available, for example, as the Genapol®X and the Genapol®O series (Clariant), the Crovol®M series (Croda) or the Lutensol® series (BASF),
2) polyalkoxylated, preferably polyethoxylated arylalkylphenols, such as, for example, 2,4,6-tris(1-phenylethyl)phenol (tristyrylphenol) having an average degree of ethoxylation between 10 and 80, preferably from 16 to 40, such as, for example, Soprophor®BSU (Rhodia) or HOE S 3474 (Clariant),
3) polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, the Arkopal®N series or the Sapogenat®T series (Clariant),
4) polyalkoxylated, preferably polyethoxylated, hydroxy fatty acids or glycerides which contain hydroxy fatty acids, such as, for example, ricinine or castor oil, having a degree of ethoxylation of between 10 and 80, preferably from 25 to 40, such as, for example, the Emulsogen®EL series (Clariant) or the Agnique®CSO series (Cognis),
5) polyalkoxylated, preferably polyethoxylated, sorbitan esters, such as, for example, Atplus®309 F (Uniqema) or the Alkamuls® series (Rhodia),
6) polyalkoxylated, preferably polyethoxylated, amines, such as, for example, the Genamin® series (Clarian), the Imbentin® CAM series (Kolb) or the Lutensol® FA series (BASF),
7) di- and tri-block copolymers, for example from alkylene oxides, for example from ethylene oxide and propylene oxide, having average molar masses between 200 and 10 000, preferably from 1000 to 4000, g/mol, the proportion by mass of the polyethoxylated block varying between 10 and 80%, such as, for example, the Genapol®PF series (Clariant), the Pluronic® series (BASF), or the Synperonic®PE series (Uniqema).

Preferred nonionic surfactants are, for example, polyethoxylated alcohols, polyethoxylated triglycerides which contain hydroxy fatty acids and polyethylene oxide/polypropylene oxide block copolymers.

If the herbicidal compositions according to the invention comprise nonionic surfactants, their proportion by weight is generally between 1 and 20% by weight.

Suitable ionic surfactants are, for example:
1) polyalkoxylated, preferably polyethoxylated, surfactants which are ionically modified, for example by conversion of the terminal free hydroxyl function of the polyethylene oxide block into a sulfate or phosphate ester (for example as alkali metal and alkaline earth metal salts), such as, for example, Genapol®LRO or Dispergiermittel 3618 (Clariant), Emulphor® (BASF) or Crafol®AP (Cognis),
2) alkali and alkaline earth metal salts of alkylarylsulfonic acids having a linear or branched alkyl chain, such as Phenylsulfonat CA or Phenylsulfonat CAL (Clariant), Atlox® 3377BM (ICI), the Empiphos®TM series (Huntsman),
3) polyelectrolytes, such as ligninsulfonates, condensates of naphthalenesulfonate and formaldehyde, polystyrenesulfonate or sulfonated unsaturated or aromatic polymers (polystyrenes, polybutadienes or polyterpenes), such as the Tamol® series (BASF), Morwet®D425 (Witco), the Kraftsperse® series (Westvaco), the Borresperse® series (Borregard).

Preferred ionic surfactants are, for example, salts of alkylsulfonic acids and their salts, alkylarylsulfonic acids and their salts and polyelectrolytes, for example from the polycondensation of naphthalenesulfonate and formaldehyde.

The herbicidal compositions according to the invention have excellent herbicidal activity and synergistic effects. By virtue of the improved control of harmful plants by the herbicidal compositions according to the invention, it is possible to lower the application rate and/or to increase the safety margin. Both make sense, economically as well as ecologically. Here, the choice of the amounts to be employed of components a) and b) and the ratio of the components a) to b) depend on various factors. Not insignificant in this context are, inter alia, the nature of the components a) and b), the development stage of the broad-leaved weeds or weed grasses, the weed spectrum to be controlled, environmental factors, climatic conditions and soil properties.

The herbicidal compositions according to the invention have a synergistically effective content of herbicidally active compounds a) and auxiliaries b). In this context, it must be emphasized in particular that, as a rule, the herbicidal compositions of the invention have an inherent synergistic action, even in combinations with application rates or weight ratios of a):b) where synergism cannot be detected readily in each individual case, for example because the individual compounds are usually employed in very different application rates in the combination or else because even the individual compounds alone effect very good control of the harmful plants.

The herbicidal compositions according to the invention can be applied, for example, by the pre-emergence method or by the post-emergence method, for example by spraying. By using the herbicidal compositions according to the invention, it is possible to reduce considerably the compound application rates required for controlling weeds.

The application rates of fatty ester b) are generally in the range from 10 g-20 kg of fatty acid ester/ha, preferably between 50 g and 5 kg of fatty acid ester/ha.

The application rates of fertilizer b) are generally in the range of 10 g-10 kg of fertilizer/ha, preferably between 50 g and 5 kg of fertilizer/ha.

The application rates of surfactants b) are generally in the range of 5 g-5 kg of surfactant/ha, preferably between 100 g and 2 kg of surfactant/ha.

As mentioned, the weight ratios a):b) of the components of the herbicidal compositions according to the invention can, like their application rates, vary within wide limits. A preferred range of application rate ratios, based on weight, comprises a):b) such as 1:1 to 1:1000, preferably 1:5 to about 1:1000.

The herbicidal compositions according to the invention may be present, for example, as mixed formulations of the two components a) and b), preferably as liquid mixed formulations, such as oil suspension concentrates (OD), which are then applied in a customary manner diluted with water, or are preferably prepared as tank mixes by jointly diluting the compounds a) and b), which have previously been formulated separately, with water. For application, the herbicidal compositions according to the invention are applied in particular as an aqueous dilution, for example as aqueous dispersions, aqueous suspensions, aqueous emulsions or aqueous solutions.

If the components a) and b) are formulated separately, then suitable possibilities of formulating active compound component a) are, for example, water-soluble wettable powers (WP), water-dispersible granules (WDG) and oil suspension concentrates, and the component b) can be formulated, for example, as a liquid formulation, for example as an emulsifiable concentrate (EC), for example based on a vegetable oil.

The formulation types mentioned are known in principle and are described, for example, in: Winnacker-Küchler, “Chemische Technologie” [Chemical Engineering], volume 7, C. Hauser Verlag Munich, 4th ed. 1986; Wade van Valkenburg, “Pesticide Formulations”, Marcel Dekker N. Y., 1973; K. Martens, “Spray Drying Handbook”, 3rd ed. 1979, G. Goodwin Ltd. London.

The herbicidal compositions according to the invention are expediently applied using additives customary in crop protection, such as liquid and/or solid carriers or diluents.

Suitable liquid carriers are, for example, aliphatic and aromatic hydrocarbons, such as toluene, xylene, or else cyclohexanone, isophorone, dimethyl sulfoxide, dimethylformamide or mineral oil fractions.

Examples of suitable solid carriers are, for example, minerals, such as bentonite, silica gel, talc, kaolin, attapulgite, limestone, and products of vegetable origin, such as meals.

The possible additives such as inert materials, solvents and further additives are likewise known and are described, for example, in: Watkins, “Handbook of Insecticide Dust Diluents and Carriers”, 2nd ed., Darland Books, Caldweil N. J.; H. v. Olphen Introduction to Clay Colloid Chemistry, 2nd ed., J. Wiley & Sons, N. Y.; Marsden “Solvents Guide, 2nd ed., Interscience, N. Y. 1963; McCutcheon's “Detergents and Emulsifiers Annual”, MC Publ. Corp., Ridgewood N. J.; Sisley and Wood, “Encyclopedia of Surface Active Agents”, Chem. Publ. Co. Inc., N. Y. 1964; Schönfeldt, “Grenzflächenaktive Äthylenoxidaddukte” [Surface-active ethylene oxide adducts], Wiss. Verlagsgesellschaft, Stuttgart 1976; Winnacker-Küchler “Chemische Technologie”, volume 7, C. Hauser Verlag Munich, 4th ed. 1986.

Based on these formulations, it is also possible to prepare combinations with other agrochemically active compounds, such as herbicides different from component a), insecticides, fungicides, antidotes or safeners and/or growth regulators, for example in the form of a ready mix or a tank mix.

If the components a) and b) are formulated separately, possible formulations for the active compound component a) are, for example, water-soluble wettable powders (WP), water-dispersible granules (WDG) and oil suspension concentrates.

Wettable powders are preparations which are uniformly dispersible in water and which, in addition to the active compounds, also comprise ionic and/or nonionic surfactants (wetting agents, dispersants), for example polyethoxylated alkylphenols, polyoxyethylated fatty alcohols and fatty amines, fatty alcohol polyglycol ether sulfates, alkanesulfonates or alkylarylsulfonates, sodium 2,2′-dinaphthyl-methane-6,6′-disulfonate, sodium dibutyinaphthalenesulfonate or else sodium oleylmethyltaurinate, in addition to a diluent or inert substance.

Granules can be produced either by spraying the active compound, or active compounds, onto adsorptive, granulated inert material or by applying active compound concentrates to the surface of a carrier such as sand, kaolinites or of granulated inert material, by means of stickers, for example sugars such as pentoses or hexoses, or else mineral oils. In general, water-dispersible granules are prepared by the customary methods, such as spray drying, fluidized-bed granulation, disk granulation, mixing using high-speed mixers and extrusion without solid inert material. Suitable active compounds can also be granulated in a manner which is customary for preparing fertilizer granules, if desired in a mixture with fertilizers.

One possibility of formulating the auxiliaries b) is, for example, emulsifiable concentrates (EC). Emulsifiable concentrates are prepared, for example, by dissolving or emulsifying the vegetable oil in an organic solvent, for example butanol, cyclohexanone, dimethylformamide, xylene or else higher-boiling aromatics or hydrocarbons with addition of one or more ionic and/or nonionic surfactants (emulsifiers). Examples of emulsifiers which can be used are: calcium alkylaryl-sulfonates, such as calcium dodecylbenzenesulfonate, or nonionic emulsifiers, such as fatty acid polyglycol esters, alkylaryl polyglycol ethers, fatty alcohol polyglycol ethers, propylene oxide-ethylene oxide condensates (for example block copolymers), alkyl polyethers, sorbitan fatty esters, polyoxyethylene sorbitan fatty esters or other polyoxyethylene sorbitan esters.

The herbicidal compositions of the present invention are prepared especially advantageously by mixing the active compounds a) with one or more components b) by the tank-mix method. To this end, component a), for example in the form of an active compound formulation such as WP, WDG or OD, is mixed with component b), for example in the form of an EC, and with water, for example by stirring. The sequence in which the individual components are added is arbitrary. Thus, for example, it is possible to first introduce water into a mixing vessel, for example the spray tank, and to add component a) and then component b). It is also possible to first introduce component b) into the water and then component a), or the components a) and b) are added simultaneously to the water.

Components a) and b) may also be present jointly in admixed formulation, for example as oil suspension concentrate, which is diluted with water in a customary manner and applied.

Oil suspension concentrates can be prepared, for example, by wet grinding using commercially available bead mills and, if appropriate, addition of surfactants, such as, for example, those already mentioned above under the other formulation types, the oil component used preferably being a vegetable oil b).

The amount of the active compounds in the various formulations can be varied within wide ranges. The formulations comprise, for example, from about 0.1 to 95% by weight of active compounds, from about 90 to 5% by weight of liquid or solid carriers, and also, if appropriate, up to 20% by weight of surfactants. In wettable powders, the active compound concentration is, for example, from about 10 to 95% by weight, the remainder to 100% by weight being composed of customary formulation components. In the case of granules such as dispersible granules, the active compound content depends partly on whether the active compound is in liquid or solid form and on which granulation auxiliaries and fillers are used. In general, the content amounts to between 10 and 90% by weight in the case of the water-dispersible granules. In oil suspension concentrates, the active compound content is generally between 0.1 and 20% by weight, preferably between 0.5 and 10% by weight.

In addition, the abovementioned active compound formulations and auxiliary formulations may, if appropriate, comprise customary additives, such as tackifiers, dispersants, emulsifiers, penetrants, preservatives, antifreeze agents, solvents, fillers, colorants, carriers, antifoams, evaporation inhibitors, pH regulators and viscosity regulators.

By virtue of the relatively low application rate of the herbicidal compositions according to the invention they are generally already well tolerated. In particular, the combinations according to the invention permit the absolute application rate to be reduced in comparison with the individual application of a herbicidally active compound.

To increase, if desired, the compatibility and/or selectivity of the herbicidal compositions according to the invention even further, it may be advantageous to apply them jointly as a mixture or successively at different times together with safeners or antidotes.

Accordingly, as optional component c), the herbicidal compositions according to the invention may comprise safeners suitable for reducing or preventing damage to the crop plant. Suitable safeners are known, for example, from WO-A-96/14747 and the literature cited therein.

Suitable safeners are, for example, the following groups of compounds:
1) Compounds of the type of dichlorophenylpyrazoline-3-carboxylic acid (S1), preferably compounds such as ethyl 1-(2,4-dichlorophenyl)-5-(ethoxy-carbonyl)-5-methyl-2-pyrazoline-3-carboxylate (S1-1, mefenpyr-diethyl, PM pp. 781-782), and related compounds, as described in WO 91/07874.
2) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
3) Compounds of the type of the triazolecarboxylic acids, preferably compounds such as fenchlorazole, i.e. ethyl 1-(2,4-dichlorophenyl)-5-trichloro-methyl-(1H)-1,2,4-triazole-3-carboxylate (S1-6, fenchlorazole-ethyl, PM pp. 385-386), and related compounds (see EP-A-174 562 and EP-A-346 620).
4) Compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9, isoxadifen-ethyl) or n-propyl ester (S1-10) or ethyl 5-(4-fluorophenyl)-5-phenyl-2-isoxazoline-3-carboxylate (S1-11), as described in the patent application (WO-A-95/07897).
5) Compounds of the type of the 8-quinolineoxyacetic acid (S2), preferably 1-methylhex-1-yl(5-chloro-8-quinolineoxy)acetate (S2-1, cloquintocet-mexyl, PM pp. 263-264), 1,3-dimethylbut-1-yl(5-chloro-8-quinolineoxy)acetate (S2-2), 4-allyloxybutyl(5-chloro-8-quinolineoxy)acetate (S2-3), 1-allyloxyprop-2-yl(5-chloro-8-quinolineoxy)acetate (S2-4), ethyl(5-chloro-8-quinolineoxy)acetate (S2-5), methyl(5-chloro-8-quinolineoxy)acetate (S2-6), allyl(5-chloro-8-quinolineoxy)acetate (S2-7), 2-(2-propylideneiminooxy)-1-ethyl(5-chloro-8-quinolineoxy)acetate (S2-8), 2-oxoprop-1-yl(5-chloro-8-quinolineoxy)acetate (S2-9) and related compounds, as described in EP-A-86 750, EP-A-94 349 and EP-A-191 736 or EP-A-0 492 366.
6) Compounds of the type of the (5-chloro-8-quinolineoxy)malonic acid, preferably compounds such as diethyl(5-chloro-8-quinolineoxy)malonate, diallyl(5-chloro-8-quinolineoxy)malonate, methyl ethyl(5-chloro-8-quinoline-oxy)malonate and related compounds, as described in EP-A-0 582 198.
7) Active compounds of the type of the phenoxyacetic or -propionic acid derivatives or the aromatic carboxylic acids, such as, for example, 2,4-dichlorophenoxyacetic acid(esters) (2,4-D), 4-chloro-2-methylphenoxy-propionic esters(mecoprop), MCPA or 3,6-dichloro-2-methoxybenzoic acid(esters)(dicamba).
8) Active compounds of the type of the pyrimidines, such as “fenclorim” (PM, pp. 512-511) (=4,6-dichloro-2-phenylpyrimidine).
9) Active compounds of the type of the dichloroacetamides, which are frequently used as pre-emergence safeners (soil-acting safeners), such as, for example, “dichlormid” (PM, pp. 363-364) (=N,N-diallyl-2,2-dichloroacetamide), “R-29148” (=3-dichloroacetyl-2,2,5-trimethyl-1,3-oxazolidone from Stauffer), “benoxacor” (PM, pp. 102-103) (=4-dichloroacetyl-3,4-dihydro-3-methyl-2H-1,4-benzoxazine, S-4), “PPG-1292” (=N-allyl-N-[(1,3-dioxolan-2-yl)methyl]dichloroacetamide from PPG Industries), “DK-24” (=N-allyl-N-[(allylaminocarbonyl)methyl]dichloroacetamide from Sagro-Chem), “AD-67” or “MON 4660” (=3-dichloroacetyl-1-oxa-3-azaspiro[4,5]decane from Nitrokemia or Monsanto), “dicyclonon” or “BAS145138” or “LAB145138” (=(=3-dichloroacetyl-2,5,5-tri-methyl-1,3-diazabicyclo[4.3.0]nonane from BASF) and “furilazol” or “MON 13900” (see PM, 637-638) (=(RS)-3-dichloroacetyl-5-(2-furyl)-2,2-dimethyloxazolidone).
10) Active compounds of the type of the dichloroacetone derivatives, such as, for example, “MG 191” (CAS-Reg. No. 96420-72-3) (=2-dichloromethyl-2-methyl-1,3-dioxolane from Nitrokemia).
11) Active compounds of the type of the oxyimino compounds, which are known as seed dressings, such as, for example, “oxabetrinil” (PM, pp. 902-903) (=(Z)-1,3-dioxolan-2-ylmethoxyimino-(phenyl)acetonitrile), which is known as seed dressing safener against metolachlor damage, “fluxofenim” (PM, pp. 613-614) (=1-(4-chlorophenyl)-2,2,2-trifluoro-1-ethanone O-(1,3-dioxolan-2-ylmethyl)oxime which is known as seed dressing safener against metolachlor damage, and “cyometrinil” or “CGA-43089” (PM, p. 1304) (=(Z)-cyanomethoxyimino-(phenyl)acetonitrile), which is known as seed dressing safener against metolachlor damage.
12) Active compounds of the type of the thiazolecarboxylic esters, which are known as seed dressings, such as, for example, “flurazole” (PM, pp. 590-591) (=benzyl 2-chloro-4-trifluoromethyl-1,3-thiazole-5-carboxylate), which is known as seed dressing safener against alachlor and metolachlor damage.
13) Active compounds of the type of the naphthalenedicarboxylic acid derivatives, which are known as seed dressings, such as, for example, “naphthalic anhydride” (PM, p. 1342) (=1,8-naphthalenedicarboxylic anhydride), which is known as seed dressing safener for corn against thiocarbamate herbicide damage.
14) Active compounds of the type of the chromanacetic acid derivatives, such as, for example, “CL 304415” (CAS-Reg. No. 31541-57-8) (=2-84-carboxychroman-4-yl)acetic acid from American Cyanamid).
15) Active compounds which, in addition to a herbicidal action against harmful plants, also have safener action on crop plants such as, for example, “dimepiperate” or “MY-93” (PM, pp. 404-405) (=S-1-methyl-1-phenylethyl piperidine-1-thiocarboxylate), “daimuron” or “SK 23” (PM, p. 330) (=1-(1-methyl-1-phenylethyl)-3-p-tolyl-urea), “cumyluron”=“JC-940” (=3-(2-chlorophenylmethyl)-1-(1-methyl-1-phenyl-ethyl)urea, see JP-A-60087254), “methoxyphenone” or “NK 049” (=3,3′-dimethyl-4-methoxybenzophenone), “CSB” (=1-bromo-4-(chloromethylsulfonyl)benzene) (CAS-Reg No. 54091-06-4 from Kumiai).

Compounds of the type of the acylsulfamoylbenrzoamides, for example of the formula (VIII) below, which are known, for example, from WO 99/16744.

| | |
|---|---|
| | (VIII) |
| 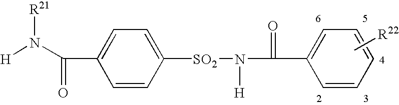 | |

| Compound No. | R²¹ | R²² |
|---|---|---|
| S3-1 | cyclopropyl | 2-OCH₃ |
| S3-2 | cyclopeopyl | 2-OCH₃, 5-Cl |
| S3-3 | ethyl | 2-OCH₃ |
| S3-4 | isopropyl | 2-OCH₃, 5-Cl |
| S3-5 | isopropyl | 2-OCH₃ |

Preferred safeners are mefenpyr, fenchlorazole, isoxadifen, cloquintocet and their C₁-C₁₀-alkyl esters, and also the safeners (S3-1=4-cyclopropylaminocarbonyl-N-(2-methoxybenzoyl)benzenesulfonamide) and benoxacor (S4), in particular mefenpyr-diethyl (S1-1), fenchlorazole-ethyl (S1-6), isoxadifen-ethyl (S1-9), cloquintocet-mexyl (S2-1), (S3-1) and benoxacor (S4).

If the herbicidal compositions according to the invention comprise safeners c), their proportion by weight is generally from 0.1 to 60% by weight, in particular from 2 to 40% by weight.

The weight ratio of component a) to component c) can vary within a wide range and is generally between 1:100 and 100:1, preferably between 1:10 and 10:1.

Agrochemically active-compounds d) different from components a) and c), such as herbicides, fungicides, insecticides, plant growth regulators and the like, may optionally be present.

Suitable agrochemically active compounds (d) different from components (a) and (c), which active compounds (d) are optionally present in the herbicidal compositions according to the invention, are in particular herbicides, for example the known herbicides mentioned below as described, for example, in Weed Research 26, 441-445 (1986), or in “The Pesticide Manual”, 13th edition, The British Crop Protection Council, 2003, and the literature cited therein, for example in mixed formulations or as tank mix components. The compounds are referred to either by the “common name” according to the International Organization for Standardization (ISO) or by the chemical name, if appropriate together with a customary code number and in each case include all application forms, such as acids, salts, esters and isomers, such as stereoisomers and optical isomers: 2,4-D, acetochlor, acifluorfen, acifluorfen-sodium, aclonifen, alachlor, alloxydim, alloxydim-sodium, ametryn, amicarbazone, amidosulfuron, aminopyralid, amitrole, anilofos, asulam, atrazine, azafenidin, azimsulfuron, beflubutamid, benazolin, benazolin-ethyl, benfuresate, bensulfuron-methyl, bentazone, benzfendizone, benzobicyclon, benzofenap, bifenox, bilanafos, bispyribac-sodium, bromacil, bromobutide, bromofenoxim, bromoxynil, butachlor, butafenacil, butenachlor, butralin, butroxydim, butylate, cafenstrole, carbetamide, carfentrazone-ethyl, chlomethoxyfen, chloridazon, chlorimuron-ethyl, chlornitrofen, chlorotoluron, chlorsulfuron, cinidon-ethyl, cinmethylin, cinosulfuron, clefoxydim, clethodim, clodinafop-propargyl, clomazone, clomeprop, clopyralid, cloransulam-ethyl, cumyluron, cyanazine, cyclosulfamuron, cycloxydim, cyhalofop-butyl, desmedipham, dicamba, dichlobenil, dichlorprop, dichlorprop-P, diclofop-methyl, diclosulam, difenzoquat, diflufenican, diflufenzopyr, dikegulac-sodium, dimefuron, dimepiperate, dimethachlor, dimethametryn, dimethenamid, diquat-dibromide, dithiopyr, diuron, dymron, EPTC, esprocarb, ethalfluralin, ethametsulfuron-methyl, ethofumesate, ethoxyfen, ethoxysulfuron, etobenzanid, fenoxaprop-ethyl, fenoxaprop-P-ethyl, fentrazamide, flamprop-M-isopropyl, flamprop-M-methyl, flazasulfuron, florasulam, fluazifop, fluazifop-butyl, fluazolate, flucarbazone-sodium, flucetosulfuron, fluchloralin, flufenacet, flufenpyr, flumetsulam, flumiclorac-pentyl, flumioxazin, fluometuron, fluorochloridone, fluoroglycofen-ethyl, flupoxam, flupyrsulfuron-methyl-sodium, fluridone, fluroxypyr, fluroxypyr-butoxypropyl, fluroxypyr-meptyl, flurprimidol, flurtamone, fluthiacet-methyl, fomesafen, foramsulfuron, glufosinate, glufosinate-ammonium, glyphosate, halosulfuron-methyl, haloxyfop, haloxyfop-ethoxyethyl, haloxyfop-methyl, haloxyfop-P-methyl, hexazinone, imazamethabenz-methyl, imazamox, imazapic, imazapyr, imazaquin, imazethapyr, imazosulfuron, indanofan, iodosulfuron-methyl-natrium, ioxynil, isoproturon, isouron, isoxaben, isoxachlortole, isoxaflutole, ketospiradox, lactofen, lenacil, linuron, MCPA, mecoprop, mecoprop-P, mefenacet, mesosulfuron-methyl, mesotrione, metamifop, metamitron, metazachlor, methabenzthiazuron, methyldymron, metobromuron, metolachlor, metosulam, metoxuron, metribuzin, metsulfuron-methyl, molinate, monolinuron, naproanilide, napropamide, neburon, nicosulfuron, norflurazon, orbencarb, oryzalin, oxadiargyl, oxadiazon, oxasulfuron, oxaziclomefone, oxyfluorfen, paraquat, pelargonic acid, pendimethalin, pendralin, penoxsulam, pentoxazone, pethoxamid, phenmedipham, picloram, picolinafen, pinoxaden, piperophos, pretilachlor, primisulfuron-methyl, profluazol, profoxydim, prometryn, propachlor, propanil, propaquizafop, propisochlor, propoxycarbazone-sodium, propyzamide, prosulfocarb, prosulfuron, pyraclonil, pyraflufen-ethyl, pyrazolate, pyrazosulfuron-ethyl, pyrazoxyfen, pyribenzoxim, pyributicarb, pyridafol, pyridate, pyriftalid, pyriminobac-methyl, pyrithiobac-sodium, quinclorac, quinmerac, quinoclamine, quizalofop-ethyl, quizalofop-P-ethyl, quizalofop-P-tefuryl, rimsulfuron, sethoxydim, simazine, simetryn, S-metolachlor, sulcotrione, sulfentrazone, sulfometuron-methyl, sulfosate, sulfosulfuron, tebuthiuron, tepraloxydim, terbuthylazine, terbutryn, thenylchlor, thiazopyr, thifensulfuron-methyl, thiobencarb, tiocarbazil, tralkoxydim, triallate, triasulfuron, triaziflam, tribenuron-methyl, triclopyr, tridiphane, trifloxysulfuron, trifluralin, triflusulfuron-methyl, tritosulfuron, 4-(4,5-di-hydro-4-methyl-5-oxo-3-trifluoromethyl-1H-1,2,4-triazol-1-yl)-2-(ethylsulfonylamino)-5-fluorobenzenecarbothioamide (HWH4991, cf. WO-A-95/30661), 2-chloro-N-[1-(2,6-dichloro-4-difluoromethylphenyl)-4-nitro-1H-pyrazol-5-yl]propanecarboxamide (SLA5599, cf. EP-A-303153), and the compounds

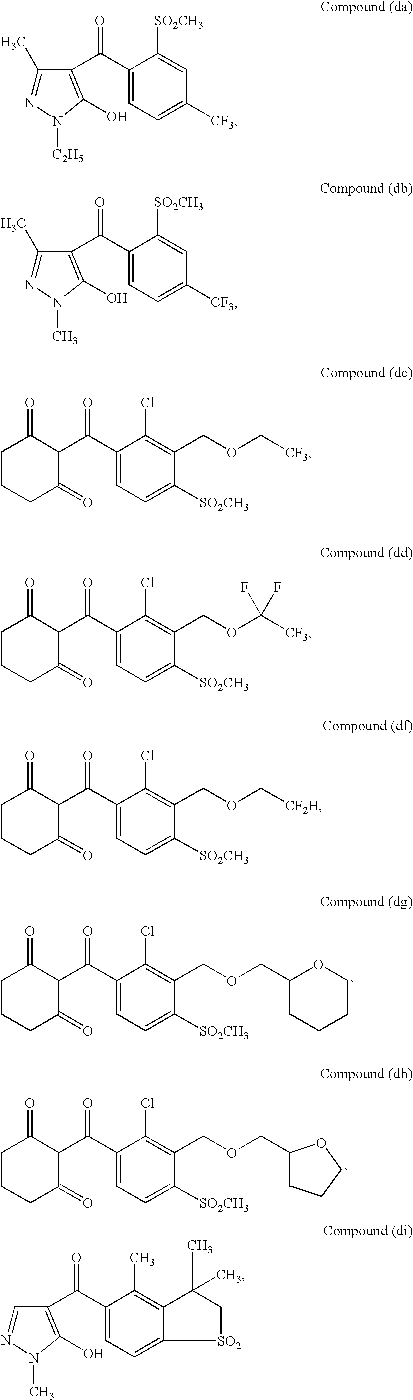

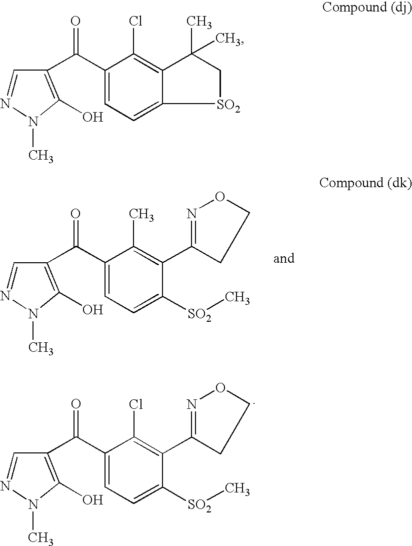

The compounds (da) and (db) are known from WO 01/74785, the active compounds (dc) to (dh) are known from WO 00/21924 and the other active compounds (di) to (dl) are known from WO 96/26206, WO 96/25412 and US 20020016262.

Preferred components d) are herbicides of the subgroups (d1) to (d4) below (most of the herbicides are referred to by the “common name”, if possible according to the reference “The Pesticide Manual”, British Crop Protection Council 1997, 11th ed., abbreviated “PM”, or 2003, 13th ed., abbreviated “PM13”):
(d1) herbicides which are active against monocotyledonous and dicotyledonous harmful plants, for example
(d1.1) flufenacet (BAY FOE 5043) (PM, pp. 82-83), 4′-fluoro-N-isopropyl-2-(5-trifluoromethyl-1,3,4-thiadiazol-2-yloxy)acetanilide,
(d1.2) metolachlor (PM, pp. 833-834), 2-chloro-N-(2-ethyl-6-methylphenyl)-N-(2-methoxy-1-methylethyl)acetamide,
(d1.3) acetochlor (PM, pp. 10-12), 2-chloro-N-(ethoxymethyl)-N-(2-ethyl-6-methylphenyl)acetamide,
(d1.4) dimethenamid (PM, pp. 409-410), 2-chloro-N-(2,4-dimethyl-3-thienyl)-N-(2-methoxy-1-methylethyl)acetamide,
(d1.5) pethoxamid (AG Chem, New Compound Review (publ. Agranova), Vol. 17, 1999, p. 94, i.e. 2-chloro-N-(2-ethoxyethyl)-N-(2-methyl-1-phenyl-1-propenyl)acetamide,
(d1.6) atrazine (PM, pp. 55-57), N-ethyl-N′-isopropyl-6-chloro-2,4-diamino-1,3,5-triazine,
(d1.7) simazine (PM, pp. 1106-1108), 6-chloro-N,N-diethyl-2,4-diamino-1,3,5-triazine,
(d1.8) cyanazine (PM, pp. 280-283), 2-(4-chloro-6-ethylamino-1,3,5-triazin-2-ylamino)-2-methylpropionitrile,
(d1.9) terbuthylazine (PM, pp. 1168-1170), N-ethyl-N′-tert-butyl-6-chloro-2,4-diamino-1,3,5-triazine,
(d1.10) metribuzin (PM, pp. 840-841), 4-amino-6-tert-butyl-3-methylthio-1,2,4-triazin-5(4H)-one,
(d1.11) terbutryn (PM, pp. 1170-1172), N-(1,1-dimethylethyl)-N′-ethyl-6-(methylthio)-1,3,5-triazine-2,4-diamine,
(d1.12) nicosulfuron (PM, pp. 877-879), 2-(4,6-dimethoxypyrimidin-2-yl)-3-(3-dimethylcarbamoyl-2-pyridylsulfonyl)urea and its salts,
(d1.13) rimsulfuron (PM, pp. 1095-1097), 1-(4,6-dimethoxypyrimidin-2-yl)-3-(3-ethylsulfonyl-2-pyridylsulfonyl)urea and its salts,
(d1.14) primisulfuron and esters, such as the methyl ester (PM, pp. 997-999), 2-[4,6-bis(difluoromethoxy)pyrimidin-2-ylcarbamoylsulfamoyl]benzoic acid or methyl 2-[4,6-bis(difluoromethoxy)pyrimidin-2-ylcarbamoylsulfamoyl]benzoate, and their salts,
(d1.15) halosulfuron (PM, pp. 657-659), 3-chloro-5-(4,6-dimethoxypyrimidin-2-ylcarbamoylsulfamoyl)-1-methylpyrazole-4-carboxylic acid and its esters and salts, preferably the methyl ester,
(d1.16) iodosulfuron (PM13, pp. 573-574) and, preferably, esters, such as the methyl ester, and salts thereof (cf. WO 96/41537 which is expressly included herein by way of reference), 4-iodo-2-(4-methoxy-6-methyl-1,3,5-triazin-2-ylcarbamoylsulfamoyl)benzoic acid or methyl 4-iodo-2-(4-methoxy-6-methyl-1,3,5-triazin-2-ylcarbamoylsulfamoyl)benzoate and their salts, such as the sodium salt, known from WO-A-92/13845, which is expressly incorporated herein by way of reference,
(d1.17) foramsulfuron and its salts (PM13, pp. 494-495), 1-(4,6-dimethoxypyrimidin-2-yl)-3-[2-(dimethylcarbamoyl)-5-formamido-phenylsulfonyl]urea,
(d1.18) pendimethalin (PM, pp. 937-939), N-(1-ethylpropyl)-2,6-dinitro-3,4-xylidine,
(d1.19) sulcotrione (PM, pp. 1124-1125), 2-(2-chloro-4-mesyl-benzoyl)cyclohexane-1,3-dione,
(d1.20) dicamba (PM, pp. 356-357), 3,6-dichloro-o-anisic acid and its salts,
(d1.21) mesotrione, 2-(4-mesyl-2-nitrobenzoyl)cyclohexane-1,3-dione (ZA 1296, cf. Weed Science Society of America (WSSA) in WSSA Abstracts 1999, Vol. 39, pages 65-66, numbers 130-132),
(d1.22) linuron (PM, pp. 751-753), 3-(3,4-dichlorophenyl)-1-methoxy-1-methylurea,
(d1.23) isoxachlortole (AG Chem, New Compound Review, publ. Agranova, Vol. 16, 1998, p. 39), i.e. 4-chloro-2-(methylsulfonyl)phenyl 5-cyclopropylisoxazol-4-yl ketone,
(d1.24) isoxaflutole (PM, pp. 737-739), (5-cyclopropylisoxazol-4-yl) 2-(methylsulfonyl)-4-(trifluoromethyl)phenyl methanone,
(d1.25) metosulam (PM, pp. 836-838), 2′,6′-dichloro-5,7-dimethoxy-3′-methyl[1,2,4]triazolo[1,5-a]pyrimidine-2-sulfonamide,
(d1.26) flumetsulam (PM, pp. 573-574), 2′,6′-difluoro-5-methyl[1,2,4]triazolo[1,5-a]pyrimidine-2-sulfonamide,
(d1.27) cloransulam and esters, such as the methyl ester (PM, p. 265), 3-chloro-2-(5-ethoxy-7-fluoro[1,2,4]triazolo[1,5-c]pyrimidin-2-ylsulfonamido)benzoic acid and, preferably, the methyl ester,
(d1.28) florasulam (Zeitschrift für Pflanzenkrankheiten und Pflanzenschutz, Verlag Eugen Ulmer, Stuttgart, Special Edition XVI, 1998, pp. 527-534), N-(2,6-difluorophenyl)-8-fluoro-5-methoxy(1,2,4)triazolo[1,5-c]pyrimidine-2-sulfonamide,
(d1.29) molinate (PM, pp. 847-849), N-(ethylthiocarbonyl)azepan,
(d1.30) thiobencarb (PM, pp. 1192-1193), 4-chlorobenzyl N,N-diethyl-thiocarbamate,
(d1.31) quinchlorac (PM, pp. 1078-1080), 3,7-dichloroquinoline-8-carboxylic acid and its salts,
(d1.32) propanil (PM, pp. 1017-1019), N-(3,4-dichlorophenyl)propanamide,
(d1.33) pyribenzoxim, benzophenone O-[2,6-bis[(4,6-dimethoxy-2-pyrimidinyl)oxy]benzoyl]oxime, conference proceedings: The 1997 Brighton Crop Protection Conference, Weeds (publ. British Crop Protection Council) pp. 39-40,
(d1.34) butachlor (PM, pp. 159-160), N-(butoxymethyl)-2-chloro-N-(2,6-diethylphenyl)acetamide,
(d1.35) pretilachlor (PM, pp. 995-996), N-(2-propoxyethyl)-2-chloro-N-(2,6-diethylphenyl)acetamide,
(d1.36) clomazone (PM, pp. 256-257), 2-[(2-chlorophenyl)-4,4-dimethyl-3-isoxazolidinone,
(d1.37) oxadiargyl (PM, pp. 904-905), 5-tert-butyl-3-[2,4-dichloro-5-(prop-2-ynyloxy)phenyl]-1,3,4-oxadiazol-2(3H)-one,
(d1.38) oxaziclomefone, 3-[1-(3,5-dichlorophenyl)-1-methylethyl]-2,3-dihydro-6-methyl-5-phenyl-4H-1,3-oxazin-4-one, conference proceedings: The 1997 Brighton Crop Protection Conference, Weeds (publ. British Crop Protection Council) pp. 73-74,
(d1.39) anilofos (PM, pp. 47-48), S-4-chloro-N-isopropylcarbaniloylmethyl O,O-dimethyl phosphorodithioate,
(d1.40) cafenstrole (PM, pp. 173-174), 1-diethylcarbamoyl-3-(2,4,6-trimethylphenylsulfonyl)-1,2,4-triazole,
(d1.41) thiazopyr (PM, pp. 1185-1187), methyl 2-difluoromethyl-5-(4,5-dihydro-1,3-thiazol-2-yl)-4-isobutyl-6-trifluoromethylnicotinate,
(d1.42) triclopyr (PM, pp. 1237-1239), [(3,5,6-trichloro-2-pyridinyl)oxy]acetic acid, preferably as triclopyr, triclopyr-butotyl, triclopyr-triethylammonium, (d1.43) oxadiazone (PM, pp. 905-907), 5-tert-butyl-3-(2,4-dichloro-5-isopropoxyphenyl)-1,3,4-oxadiazol-2(3H)-one,
(d1.44) esprocarb (PM, pp. 472-473), S-benzyl 1,2-dimethylpropyl-(ethyl)thiocarbamate,
(d1.45) pyributicarb (PM, pp.1060-1061), O-3-tert-butylphenyl-6-methoxy-2-pyridyl methylthiocarbamnate (TSH-888),
(d1.46) azimsulfuron (PM, pp. 63-65), 1-(4,6-dimethoxypyrimidin-2-yl)-3-[1-methyl-4-(2-methyl-2H-tetrazol-5-yl)pyrazol-5-yl]sulfonylurea,
(d1.47) azoles, as known from EP-A-0663913, which is expressly incorporated herein by way of reference, for example 1-(3-chloro-4,5,6,7-tetrahydropyrazolo[1,5-a]pyridin-2-yl)-5-methylpropargylamino)-4-pyrazolylcarbonitrile (hereinbelow “EP 913”),
(d1.48) thenyichlor (PM, pp. 1182-1183), 2-chloro-N-(3-methoxy-2-thenyl)-2′,6′-dimethylacetanilide, (d1.49) pentoxazone (PM, pp. 942-943), 3-(4-chloro-5-cyclopentyloxy-2-fluorophenyl)-5-isopropylidene-1,3-oxazolidine-2,4-dione, (d1.50) pyriminobac and its esters, such as the methyl ester (PM, pp.1071-1072), methyl 2-(4,6-dimethoxy-2-pyrimidinyloxy)-6-(1-methoxyiminoethyl)benzoate, also as acid or sodium salt,
(d1.51) mesosulfuron and its salts and esters (PM, p. 630), methyl 2-[(4,6-dimethoxypyrimidin-2-ylcarbamoyl)sulfamoyl]α-(methanesulfonamido)-p-toluate,
(d1.52) isoproturon (PM, pp. 732-734), 3-(4-isopropylphenyl)-1,1-dimethylurea,
(d1.53) chlortuloron (PM, pp. 229-231), 3-(3-chloro-p-tolyl)-1,1-dimethylurea,
(d1.54) prosulfocarb (PM, pp. 1039-1041), S-benzyl dipropylthiocarbamate,
(d1.55) flucarbazone and its salts (PM13, pp. 447-448), 4,5-dihydro-3-methoxy-4-methyl-5-oxo-N-(2-trifluoromethoxyphenylsulfonyl)-1H-1,2,4-triazole-1-carboxamide sodium,
(d1.56) propoxycarbazone and its salts (PM,. pp. 831-832), methyl 2-[[[(4,5-dihydro-4-methyl-5-oxo-3-propoxy-1H-1,2,4-triazol-1-yl)carbonyl]amino]sulfonyl]benzoate, sodium salt,
(d1.57) flupyrsulfuron and its esters, such as the methyl ester, and their salts (PM, pp. 586-588), methyl 2-(4,6-dimethoxypyrimidin-2-ylcarbamoylsulfamoyl)-6-trifluoromethyinicotinate sodium,
(d1.58) sulfosulfuron and its salts (PM, pp. 1130-1131), 1-(4,6-dimethoxypyrimidin-2-yl)-3-(2-ethylsulfonylimidazo[1,2-a]pyridin-3-yl)sulfonylurea,
(d1.59) trifluralin (PM13, pp. 1012-1014), α,α,α-trifluoro-2,6-dinitro-N,N-dipropyl-p-toluidine,
(d1.60) ethalfluralin (PM13, pp. 375-376), N-ethyl-α,α,α-trifluoro-N-(2-methylallyl)-2,6-dinitro-p-toluidine,
(d1.61) norflurazon (PM13, pp. 711-712), 4-chloro-5-methylamino-2-(α,α,α-trifluoro-m-tolyl)pyridazin-3(2H)-one,
(d1.62) vernolate (PM13, p. 1099), S-propyl dipropylthiocarbamate,
(d1.63) chlorotoluron (PM13, p. 170), 3-(3-chloro-p-tolyl)-1,1-dimethylurea,
(d1.64) imazethapyr and its salts and esters (PM13, pp. 558-560), (RS)-5-ethyl-2-(4-isopropyl-4-methyl-5-oxo-2-imidazolin-2-yl)nicotinic acid,
(d1.65) imazamox (PM13, pp. 552-553), (RS)-2-(4-isopropyl-4-methyl-5-oxo-2-imidazolin-2-yl)-5-methoxymethyinicotinic acid,
(d1.66) imazaquin and its salts and esters (PM13, pp. 557-558), (RS)-2-(4-isopropyl-4-methyl-5-oxo-2-imidazolin-2-yl)quinoline-3-carboxylic acid,
(d2) herbicides which are mainly active against dicotyledonous harmful plants, for example
(d2.1) MCPA (PM, pp. 767-769), (4-chloro-2-methylphenoxy)acetic acid and its salts and esters,
(d2.2) 2,4-D (PM, pp. 323-327), 2,4-dichlorophenoxyacetic acid and its salts and esters,
(d2.3) bromoxynil (PM, pp. 149-151), 3,5-dibromo-4-hydroxybenzonitrile,
(d2.4) bentazone (PM, pp.1064-1066), 3-isopropyl-2,2-dioxo-1H-2,1,3-benzothiadiazin-4(3H)-one,
(d2.5) fluthiacet (PM, pp. 606-608), [2-chloro-4-fluoro-5-(5,6,7,8-tetrahydro-3-oxo-1H,3H-1,3,4-thiadiazolo[3,4-a]pyridazin-1-ylideneamino)phenylthio]acetic acid and, preferably, the methyl: ester,
(d2.6) pyridate (PM, pp. 1064-1066), O-(6-chloro-3-phenylpyridazin-4-yl) S-(octyl)thiocarbonate,
(d2.7) diflufenzopyr (BAS 654 00 H, PM pp. 81-82), 2-{1-[4-(3,5-difluorophenyl)semicarbazono]ethyl}nicotinic acid,
(d2.8) carfentrazone (PM, pp. 191-193), ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate, used, inter alia, as carfentrazone-ethyl (as stated) or else as acid,
(d2.9) clopyralid (PM, pp. 260-263), 3,6-dichloropyridine-2-carboxylic acid,
(d2.10) thifensulfuron and its esters, preferably the methyl ester (PM, pp. 1188-1190), 3-[[[[(4-methoxy-6-methyl-1,3,5-triazin-2-yl)amino]-carbonyl]amino]sulfonyl]-2-thiophenecarboxylic acid or methyl 3-[[[[(4-methoxy-6-methyl-1,3,5-triazin-2-yl)amino]carbonyl]amino]sulfonyl]-2-thiophenecarboxylate and its salts,
(d2.11) prosulfuron and its salts (PM, pp. 1041-1043), 1-(4-methoxy-6-methyl-1,3,5-triazin-2-yl)-3-[2-(3,3,3-trifluoropropyl)phenylsulfonyl]urea and its salts,
(d2.12) tritosulfuron and its salts (PM13, p. 1022; AG Chem, New Compound Review (publ. Agranova), Vol. 17, 1999, p. 24), N-[[[4′-methoxy-6-(trifluoromethyl)-1,3,5-triazin-2-yl]amino]carbonyl]-2-trifluoromethylbenzenesulfonamide,
(d2.13) triasulfuron and its salts (PM, pp. 1222-1224), 1-[2-(2-chloroethoxy)phenylsulfonyl]-3-(4-methoxy-6-methyl-1,3,5-triazin-2-yl)urea,
(d2.14) 2,4-D (PM, pp. 323-327), (2,4-dichlorophenoxy)acetic acid, frequently used forms: 2,4-D-butotyl, 2,4-D-butyl, 2,4-D-dimethylammonium, 2,4-D-diolamine, 2,4-D-isobctyl, 2,4-D-isopropyl, 2,4-D-triolamine,
(d2.15) MCPA (PM, pp. 770-771), (4-chloro-2-methylphenoxy)acetic acid, the forms that are mainly used are, inter alia, MCPA-butotyl, MCPA-dimethylammonium, MCPA-isoctyl, MCPA-potassium, MCPA-sodium,
(d2.16) bensulfuron and its esters, preferably the methyl ester, and their salts (PM, pp. 104-105), methyl α-(4,6-dimethoxypyrimidin-2-yl-carbamoylsulfamoyl)-O-toluate,
(d2.17) metsulfuron and its esters, preferably the methyl ester, and their salts (PM, pp. 842-844), methyl 2-[[[[(4-methoxy-6-methyl-1,3,5-triazin-2-yl)amino]carbonyl]amino]sulfonyl]benzoate,
(d2.18) acifluorfen (PM, pp. 12-14), 5-(2-chloro-α,α,α-trifluoro-p-tolyloxy)-2-nitrobenzoic acid, also used as acifluorfen-sodium,
(d2.19) bispyribac (KIH 2023), preferred is the form as sodium salt (PM, pp. 129-131), sodium 2,6-bis[(4,6-dimethoxypyrimidin-2-yl)oxy]benzoate,
(d2.20) ethoxysulfuron and its esters and salts (PM, pp. 488-490), 1-(4,6-dimethoxypyrimidin-2-yl)-3-(2-ethoxyphenoxysulfonyl)urea,
(d2.21) cinosulfuron and its esters and salts (PM, pp. 248-250), 1-(4,6-dimethoxy-1,3,5-triazin-2-yl)-3-[2-(2-methoxyethoxy)phenylsulfonyl]urea,
(d2.22) pyrazosulfuron and its esters, preferably the ethyl ester, and their salts (PM, pp. 1052-1054), methyl 5-(4,6-dimethoxypyrimidin-2-ylcarbamoylsulfamoyl)-1-methylpyrazole-4-carboxylate,
(d2.23) imazosulfuron and its esters and salts (PM, pp. 703-704), 1-(2-chloroimidazo[1,2-a]pyridin-3-ylsulfonyl)-3-(4,6-dimethoxypyrimidin-2-yl)urea,
(d2.24) cyclosulfamuron and its esters and salts (PM, pp. 288-289), N-[[[2-(cyclopropylcarbonyl)phenyl]amino]sulfonyl]-N1-(4,6-dimethoxypyrimidin-2-yl)urea,
(d2.25) chlorsulfuron and its esters and salts (PM, pp. 239-240), 1-(2-chlorophenylsulfonyl)-3-(4-methoxy-6-methyl-1,3,5-triazin-2-yl)urea,
(d2.26) bromobutide (PM, pp. 144-145), 2-bromo-3,3-dimethyl-N-(1-methyl-1-phenylethyl)butyramide,
(d2.27) bentazone (PM, pp. 109-111), 3-isopropyl-1H-2,1,3-benzothiadiazin-4(3H)-one 2,2-dioxide,
(d2.28) chlorimuron and its esters, preferably the ethyl ester, and their salts (PM, pp. 217-218), ethyl 2-(4-chloro-6-methoxypyrimidin-2-yl-carbonylsulfamoyl)benzoate,
(d2.29) diflufenican (PM, pp. 397-399), 2′,4′-difluoro-2-(α,α,α-trifluoro-m-tolyloxy)nicotinanilide,
(d2.30) flurtamone (PM, pp. 602-603), (RS)-5-methylamino-2-phenyl-4-(α,α,α-trifluoro-m-tolyl)furan-3(2H)one,
(d2.31) tribenuron (PM, pp. 1230-1232), methyl 2-[[[[4-methoxy-6-methyl-1,3,5-triazin-2-yl)methylamino]carbonyl]amino]sulfonyl]benzoate,
(d2.32) amidosulfuron and its salts (PM, pp. 37-38), 1-(4,6-dimethoxypyrimidin-2-yl)-3-mesyl(methyl)sulfamoylurea,
(d2.33) mecoprop/mecoprop-P and their esters (PM, pp. 776-779), (RS)-2-(4-chloro-o-tolyloxy)propionic acid,
(d2.34) dichlorprop/dichlorprop-P and their esters (PM, pp. 368-372), (RS)-2-(2,4-dichlorophenoxy)propionic acid,
(d2.35) fluroxypyr (PM, pp. 597-600), 4-amino-3,5-dichloro-6-fluoro-2-pyridyloxyacetic acid,
(d2.36) picloram (PM, pp. 977-979), 4-amino-3,5,6-trichloropyridine-2-carboxylic acid,
(d2.37) ioxynil (PM, pp. 718-721), 4-hydroxy-3,5-diiodobenzonitrile,
(d2.38) bifenox (PM, pp. 116-117), methyl 5-(2,4-dichlorophenoxy)-2-nitrobenzoate,
(d2.39) pyraflufen-ethyl (PM, pp. 1048-1049), ethyl 2-chloro-5-(4-chloro-5-difluoromethoxy-1-methylpyrazol-3-yl)-4-fluorophenoxyacetate,
(d2.40) fluoroglycofen-ethyl (PM, pp. 580-582), O-[5-(2-chloro-α,α,α-trifluoro-p-tolyloxy)-2-nitrobenzoyl]glycolic acid,
(d2.41) cinidon-ethyl (BAS 615005) (AG Chem, New Compound Review, publ. Agranova, Vol.17, 1999, p. 26),
(d2.42) picolinafen (PM13, pp. 785-786) (AG Chem, New Compound Review, (publ. Agranova), Vol. 17, 1999, p. 35), N-4-fluorophenyl-6-(3-trifluoromethylphenoxy)pyridine-2-carboxamide,
(d2.43) sulfentrazone (PM13, pp. 910-911), 2′,4′-dichloro-5′-(4difluoromethyl-4,5-dihydro-3-methyl-5-oxo-1H-1,2,4-triazol-1-yl)methanesulfonanilide,
(d2.44) oxyfluorfen (PM13, pp. 738-739), 2-chloro-α,α,α-trifluoro-p-tolyl 3-ethoxy-4-nitrophenyl ether,
(d2.45) lactofen (PM13, pp. 596-597), ethyl O-[5-(2-chloro-α,α,α-trifluoro-p-tolyloxy)-2-nitrobenzoyl]-DL-lactate,
(d2.46) fomesafen (PM13, pp. 492-493), 5-(2-chloro-α,α,α-trifluoro-p-tolyloxy)-N-methylsulfonyl-2-nitrobenzamide,
(d2.47) flumiclorac (PM13, pp. 460-461), pentyl [2-chloro-5-(cyclohex-1-ene-1,2-dicarboximido)-4-fluorophenoxy]acetate,
(d2.48) 2,4-DB (PM13, pp. 264-266), 4-(2,4-dichlorophenoxy)butyric acid,
(d2.49) flumioxazin (PM13, pp.461-462), N-(7-fluoro-3,4-dihydro-3-oxo-4-prop-2-ynyl-2H-1,4-benzoxazin-6-yl)cyclohex-1-ene-1,2-dicarboxamide,
(d2.50) benazolin (PM13, pp. 62-64), 4-chloro-2-oxobenzothiazolin-3-ylacetic acid; 4-chloro-2,3-dihydro-2-oxobenzothiazol-3-ylacetic acid,
(d3) herbicides which are mainly active against monocotyledonous harmful plants, for example
(d3.1) quizalofop/quizalofop-P and their esters, such as the ethyl or tefuryl ester (PM, pp. 1087-1092), (RS)-2-[4-(6-chloroquinoxalin-2-yloxy)phenoxy]propionic acid,
(d3.2) fenoxaprop/fenoxaprop-P and their esters, such as the ethyl ester (PM, pp. 519-520), 2-[4-(6-chlorobenzoxazol-2-yloxy)phenoxy]propionate,
(d3.3) fluazifop/fluazifop-P and their esters, such as the butyl ester (PM, pp. 553-557), butyl (RS)-2-[4-(5-trifluoromethyl-2-pyridiyloxy)phenoxy]propionate,
(d3.4) haloxyfop/haloxyfop-P and their esters, such as the methyl ester (PM, pp. 659-663), (±)-2-[4-[[3-chloro-5-(trifluoromethyl)-2-pyridinyl]oxy]phenoxy]propionic acid including, inter alia, the application form as haloxyfop-etotyl, haloxyfop-methyl, haloxyfop-methyl [(R)-isomer],
(d3.5) propaquizafop (PM, pp. 1021-1022), 2-isopropylideneamino-oxyethyl (R)-2-[4-(6-chloroquinoxalin-2-yloxy)phenoxy]propionate,
(d3.6) clodinafop and its esters, such as the propargyl ester (PM, pp. 251-253), (R)-2-[4-(5-chloro-3-fluoro-2-pyridyloxy)phenoxy]propionic acid,
(d3.7) cyhalofop and its esters, such as the butyl ester (PM, pp. 297-298), butyl (R)-2-[4-(4-cyano-2-fluorophenoxy)phenoxy]propionate,
(d3.8) diclofop/diclofop-P and its esters, such as the methyl ester (PM, pp. 374-377), (RS)-2-[4-(2,4-dichlorophenoxy)phenoxy]propionic acid,
(d3.9) sethoxydim (PM, pp. 1101-1103), (±)-(EZ)-(1-ethoxyiminobutyl)-5-[2-(ethylthio)propyl]-3-hydroxycyclohex-2-enone,
(d3.10) cycloxydim (PM, pp. 290-291), (±)-2-[1-(ethoxyimino)butyl]-3-hydroxy-5-thian-3-ylcyclohex-2-enone,
(d3.11) clethodim (PM, pp. 250-251), (±)-2-[(E)-1-[(E)-3-chloroallyloxyimino]propyl]-5-[2-(ethylthio)propyl]-3-hydrocyclohex-2-enone,
(d3.12) profoxydim, 2-[1-(2-(4-chlorophenoxy)propoxyimino)butyl]-3-oxo-5-thian-3-ylcyclohex-1-enol (AG Chem, New Compound Review (publ. Agranova), Vol. 17, 1999, p. 26 and PM, 13th edition pp. 808-809),
(d3.13) alachlor (PM, pp. 23-24), 2-chloro-N-(2,6-diethylphenyl)-N-(methoxymethyl)acetamide,
(d3.14) mefenacet (PM, pp. 779-781), 2-(1,3-benzothiazol-3-yloxy)-N-methylacetanilide,
(d3.15) fentrazamide, 4-(2-chlorophenyl)-5-oxo-4,5-dihydrotetrazole-1-carboxamide (PM13, pp. 427-428 and conference proceedings: The 1997 Brighton Crop Protection Conference, Weeds (publ. British Crop Protection Council), pp. 67-68),
(d3.16) benfuresate (PM, pp. 98-99), 2,3-dihydro-3,3-dimethylbenzofuran-5-yl ethanesulfonate,
(d4) herbicides which are active against monocotyledonous and dicotyledonous harmful plants, for use in the non-selective field or in specifically tolerant crops, such as
(d4.1) glufosinate (PM, pp. 643-645), also including glufosinate-P, for example 4-[hydroxy(methyl)phosphinoyl]-DL-homoalanine, 4-[hydroxy(methyl phosphinoyl]-L-homoalanine, in each case preferably as salts, for example ammonium or alkali metal salts, such as
   (d4.1.1) glufosinate-ammonium,
   (d4.1.2) glufosinate-P-ammonium,
   (d4.1.3) glufosinate-sodium,
   (d4.1.4) glufosinate-P-sodium,
(d4.2) glyphosate (PM, pp. 646-649),
   N-(phosphonomethyl)glycine and its salts and esters, for example
   (d4.2.1) glyphosate-isopropylammonium,
   (d4.2.2) glyphosate-sesquisodium,
   (d4.2.3) glyphosate-trimesium,
(d4.3) paraquat and its salts, such as paraquat dichloride (PM pp. 923-925).

Imidazolinones and their salts, such as
(d4.4) imazapyr and its salts and esters (PM, pp. 697-699),
(d4.5) imazamethabenz and its salts and esters (PM, pp. 694-696),
(d4.6) imazamethabenz-methyl (PM, pp. 694-696),
(d4.7) imazapic (AC 263,222) and its salts and esters, for example the ammonium salt, (PM, pp. 5 and 6, referred to under AC 263,222).

Suitable combination partners (d) are preferably compounds which are selective in soybeans, for example
(dα) herbicides which act selectively against monocotyledonous and dicotyledonous harmful plants in soybeans, for example
(d1.59) trifluralin (PM, pp. 1248-1250),
(d1.10) metribuzin (PM, pp. 840-841),
(d1.36) clomazone (PM, pp. 256-257),
(d1.18) pendimethalin (PM, pp. 937-939),
(d1.2) metolachlor (PM, pp. 833-834),
(d1.26) flumetsulam (PM, pp. 573-574),
(d1.4) dimethenamid (PM, pp. 409-410),
(d1.22) linuron (PM, pp. 751-753),
(d1.60) ethalfluralin (PM, pp. 473-474),
(d1.1) flufenacet (BAY FOE 5043) (PM, pp. 82-83),
(d1.61) norflurazon (PM, pp. 886-888),
(d1.62) vernolate (PM, pp. 1264-1266),
(d1.63) chlortoluron, chlorotoluron (PM, pp. 229-231),
(d1.27) cloransulam and esters, such as the methyl ester (PM, p. 265),
(d1.64) imazethapyr (PM13, pp. 558-560),
(d1.65) imazamox (PM13, pp. 552-553),
(d1.66) imazaquin (PM13, pp. 557-558),
(dβ) herbicides which act selectively against dicotyledonous harmful plants in soybeans, for example
(d2.43) sulfentrazone (PM, pp. 1126-1127),
(d2.4) bentazone (PM, pp. 109-111),
(d2.10) thifensulfuron and its esters, in particular the methyl ester (PM, pp. 1188-1190),
(d2.44) oxyfluorfen (PM, pp. 919-921),
(d2.45) lactofen (PM, pp. 747-748),
(d2.46) fomesafen (PM, pp. 616-618),
(d2.47) flumiclorac (PM, pp. 575-576) and its esters, such as the pentyl ester,
(d2.18) acifluorfen and its sodium salt (PM, pp. 12-14),
(d2.48) 2,4-DB (PM, pp. 337-339) and its esters and salts,
(d2.49) flumioxazin (PM13, pp. 461-462),
(d2.50) benazolin (PM13, pp. 62-64),
(d2.2) 2,4-D (PM, pp. 323-327) and its esters and salts,
(d2.28) chlorimuron and its esters and salts, such as chlorimuron-ethyl,
(dγ) herbicides which act selectively against monocotyledonous harmful plants in soybeans, for example
(d3.9) sethoxydim (PM, pp. 1101-1103),
(d3.10) cycloxydim (PM, pp. 290-291),
(d3.11) clethodim (PM, pp. 250-251),
(d3.1) quizalofop-P and its esters, such as the ethyl or tefuryl ester (PM, pp. 1089-1092),
(d3.2) fenoxaprop-P and its esters, such as the ethyl ester (PM, pp. 519-520),
(d3.3) fluazifop-P and its esters, such as the butyl ester (PM, pp. 556-557),
(d3.4) haloxyfop and haloxyfop-P and their esters, such as the methyl or the etotyl ester (PM, pp. 660-663),
(d3.5) propaquizafop (PM, pp. 1021-1022),
(d3.13) alachlor (PM, pp. 23-24),
(dδ) nonselective herbicides which can be used in soybeans for specific purposes, for example
(d4.1) glufosinate (PM, pp. 643-645),
(d4.2) glyphosate (PM, pp. 646-649),
(d4.3) paraquat (salts), such as paraquat dichloride (PM, pp. 923-925).

Combination partners (d) which are also preferred are benozalin, fenoxaprop, lactofen, chlortoluron, flufenacet, metribuzin, benfuresate, fentrazamide, mefenacet, diclofop, ioxynil, bromoxynil, amidosulfuron, flurtamone, diflufenican, ethoxysulfuron, flucarbazone, propoxycarbazone, sulcotrione, mesotrione, isoproturon, iodosulfuron, mesosulfuron, foramsulfuron, anilofos, oxaziclomefone, oxadiargyl, isoxaflutole, linuron.

If, in the context of this description, the short form of the “common name” is used, this embraces all customary derivatives, such as the esters and salts, and isomers, in particular optical isomers, in particular the commercial form or forms. The stated chemical compound names refer to at least one of the compounds embraced by the “common name”, frequently to a preferred compound. Also included in the case of sulfonylureas are salts which are formed by exchanging a hydrogen atom at the sulfonamide group by a cation.

Preference is given to herbicidal combinations comprising one or more herbicides (a) and one or more herbicides (d), preferably from the group (d1) or (d2), (d3) or (d4). More preferred are combinations of herbicides (a) with one or more herbicides (d) according to the scheme: (a)+(d1), (a)+(d2), (a)+(d3), (a)+(d4), (a)+(d1)+(d2), (a)+(d1)+(d3), (a)+(d1)+(d4), (a)+(d2)+(d3), (a)+(d2)+(d4), (a)+(d3)+(d4) or (a)+(d1)+(d2)+(d3).

Combinations according to the invention include those combinations which additionally comprise one or more further agrochemically active compounds different from herbicides, such as safeners (for example mefenpyr-diethyl, isoxadifen-ethyl, cloquintocet-mexyl, 1,8-naphthalic anhydride, dichloromid, benoxacor, fenclorim, furilazole or n-cyclopropyl-4-[(2-methoxybenzoyl)sulfamoyl]benzamide (see WO 99/16744), insecticides or fungicides, such as (a)+(d1)+(c), (a)+(d2)+(c) oder (a)+(d3)+(c), (a)+(d4)+(c), (a)+(d1)+(d2)+(c), (a)+(d1)+(d3)+(c), (a)+(d1)+(d4)+(c), (a)+(d2)+(d3)+(c), (a)+(d2)+(d4)+(c), (a)+(d3)+(d4)+(c) or (a)+(d1)+(d2)+(d3)+(c).

The preferred conditions illustrated below in particular for two-component combinations according to the invention apply primarily also to combinations comprising three or more active compounds, if they comprise the two-component combinations according to the invention, and with respect to the two-component combination in question.

The application rates of the herbicides (d) may vary considerably depending on the herbicide. The following quantities [in g of a.i. (active ingredient)/ha (hectare)] may be used as guidelines for preferred application rates for some mixing partners of group (d), where in the combinations according to the invention even amounts of less than the lowest amount may be appropriate:

Herbicides of group (d1): 10-8000, preferably 50-5000 g of a.i./ha,

Herbicides of group (d2): 5-5000, preferably 2-2500 g of a.i./ha,

Herbicides of group (d3): 10-500, preferably 25-300 g of a.i./ha,

Herbicides of group (d4): 20-5000, preferably 100-2000 g of a.i./ha.

Ranges of suitable ratios of the compounds (a) and (d) follow, for example, from the application rates mentioned for the individual compounds. In general, in the combinations according to the invention, the application rates may be reduced. Preferred mixing ratios (a):(d) for the combinations according to the invention are listed below:

(a):(d1)=10:1 to 1:800 000, preferably 6:1 to 1:5000,

(a):(d2)=200:1 to 1:500 000, preferably 5:1 to 1:5000,

(a):(d3)=10:1 to 1:500 000, preferably 5:1 to 1:5000,

(a):(d4)=5:1 to 1:500 000, preferably 1:10 to 1:5000.

If the herbicidal compositions according to the invention comprise agrochemically active compounds d), their proportion by weight is generally from 0.5 to 50% by weight, in particular from 3 to 20% by weight.

The total content of active compounds (sum of components a)+c)+d)) contained in the herbicidal compositions according to the invention is generally between 1 and 95% by weight, in particular between 2 and 60% by weight.

The herbicidal compositions according to the invention may optionally comprise sulfosuccinates (component e), for example mono- or diesters of sulfosuccinic acid, preferably those of the formula (II)
R¹—(X₁)ₙ—O—CO—CH₂—CH(SO₃M)—CO—O—(X₂)ₘ—R² (II)
in which
R¹ is H or an unsubstituted or substituted C₁-C₃₀-hydrocarbon radical, such as C₁-C₃₀-alkyl or C₇-C₃₀-alkylaryl,
R² is H or an unsubstituted or substituted C₁-C₃₀-hydrocarbon radical, such as C₁-C₃₀-alkyl or C₇-C₃₀-alkylaryl, or a cation, for example a metal cation, such as an alkali metal or alkaline earth metal cation, or an ammonium cation, such as NH₄ or an alkyl-, alkylaryl- or poly(arylalkyl)-phenylammonium cation,
X¹, X² are identical or different and independently of one another are a spacer unit, such as a polyether unit or a polyester unit,
n, m are identical or different and independently of one another are zero or 1, preferably zero, and
M is a cation, for example a metal cation, such as an alkali metal or alkaline earth metal cation, or an ammonium cation, such as NH₄ or an alkyl-, alkylaryl- or poly(arylalkyl)phenylammonium cation.

Preference is given to sulfosuccinates of the formula (II) in which R¹ and R² are identical or different and independently of one another are linear, branched or cyclic, saturated or unsaturated C₁-C₂₀-, preferably C₄-C₁₈-, alkyl radicals, such as methyl, ethyl, butyl, hexyl, cyclohexyl, octyl, such as 2-ethylhexyl, decyl, tridecyl or octadecyl radicals, or R¹ and R² are C₇-C₂₀-alkylaryl radicals, such as nonylphenyl, 2,4,6-tri-sec-butylphenyl, 2,4,6-tris-(1-phenylethyl)phenyl, alkylbenzyl or a hydrocinnamic radical,

X₁ and X₂ are identical or different and independently of one another are polyether units, such as polyethylene glycols —(C₂H₄O)ₚ— or polypropylene glycols —(C₃H₆O)ₚ— where p=1 to p=20, in particular p=1 to p=12, or polyester units, such as polyhydroxybutyric acid —(CH[CH₃]—CH₂—COO)_{q}— or polylactic acid —(CH[CH₃]—COO)_{q}— where q=1 to q=15, in particular q=1 to q=8,

n, m are identical or different and independently of one another are zero or 1, preferably zero, and M is a cation, for example a metal cation, such as an alkali metal or alkaline earth metal cation, or an ammonium cation which may be alkyl-substituted.

Examples of sulfosuccinates present according to the invention are
a1) sulfosuccinate which is esterified once or twice with linear, cyclic or branched aliphatic, cycloaliphatic and/or aromatic alcohols, having, for example, 1 to 22 carbon atoms in the alkyl radical, preferably mono- or dialkali metal sulfosuccinate, in particular mono- or disodium sulfosuccinate, which is esterified once or twice with methanol, ethanol, (iso)propanol, (iso)butanol, (iso)pentanol, (iso)hexanol, cyclohexanol, (iso)heptanol, (iso)octanol (in particular: ethylhexanol), (iso)nonanol, (iso)decanol, (iso)undecanol, (iso)dodecanol or (iso)tridecanol,
a2) sulfosuccinate which is esterified once or twice with (poly)alkylene oxide adducts of alcohols, having, for example, 1 to 22 carbon atoms in the alkyl radical and 1 to 200, preferably 2 to 200, alkylene oxide units in the (poly)alkylene oxide moiety, preferably mono- or dialkali metal sulfosuccinate, in particular mono- or disodium sulfosuccinate, which is esterified once or twice with dodecyl/tetradecyl alcohol +2-5 mol of ethylene oxide or with i-tridecyl +3 mol of ethylene oxide,
a3) the dialkali metal salt, preferably the disodium salt, of maleic anhydride which has been reacted with one equivalent of an amine or an amino-terminated (poly)alkylene oxide adduct of an alcohol, an amine, a fatty acid, an ester or an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of coconut fatty amine and then sulfonated,
a4) the dialkali metal salt, preferably the disodium salt, of maleic anhydride which has been reacted with one equivalent of an amide or a (poly)alklene oxide adduct of an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of oleylamide +2 mol of ethylene oxide and then sulfonated, and/or
a5) the tetraalkali metal salt, preferably the tetrasodium salt, of N-(1,2-dicarboxy-ethyl)-N-octadecylsulfo-succinamate.

Examples of sulfosuccinates of groups a1) to a5) which are commercially available and preferred within the context of the present invention are listed below:
a1) sodium dialkylsulfosuccinate, for example sodium di-(C₄-C₁₈)-alkylsulfosuccinate, such as sodium diisooctylsulfosuccinate, preferably sodium di(2-ethylhexyl)sulfosuccinate, commercially available, for example, in the form of the Aerosol® brands (Cytec), the Agrilan® or Lankropol® brands (Akzo Nobel), the Empimin® brands (Albright&Wilson), the Cropol® brands (Croda), the Lutensit® brands (BASF), the Triton® brands (Union Carbide), the Geropon® brands (Rhodia) or the Imbirol®, Madeol® or Polirol® brands (Cesalpinia),
a2) sodium alcohol polyethylene glycol ether sulfosuccinate, commercially available, for example, in the form of Geropon® ACR brands (Rhodia),
a3) disodium alcohol polyethylene glycol ether semisulfosuccinate, commercially available, for example, in the form of the Aerosol® brands (Cytec), the Marlinat® or Sermul® brands (Condea), the Empicol® brands (Albright&Wilson), the Secosol® brands (Stepan), the Geropon® brands (Rhodia), the Disponil® or Texapon® brands (Cognis) or the Rolpon® brands (Cesalpinia),
a4) disodium N-alkylsulfosuccinamate, commercially available, for example, in the form of the Aerosol® brands (Cytec), the Rewopol® or Rewoderm® brands (Rewo), the Empimin® brands (Albright&Wilson), the Geropon® brands (Rhodia) or the Polirol® brands (Cesalpinia),
a5) disodium fatty acid amide polyethylene glycol ether semisulfosuccinate, commercially available, for example, in the form of the Elfanol® or Lankropol® brands (Akzo Nobel), the Rewoderm®, Rewocid® or Rewopol® brands (Rewo), the Emcol® brands (Witco), the Standapol® brands (Cognis) or the Rolpon® brands (Cesalpinia), and
a6) tetrasodium N-(1,2-dicarboxyethyl)-N-octadecylsulfosuccinamate, commercially available, for example, in the form of Aerosol 22® (Cytec).

Sulfosuccinates are commercially available, for example, as Aerosol® (Cytec), Agrilan® or Lankropol® (Akzo Nobel), Empimin® (Huntsman), Cropol® (Croda), Lutensit® (BASF), Triton® GR series (UnionCarbide), Imbirol®/Madeol®/Polirol® (Cesalpinia); as Geropon®AR series or as Geropon® SDS (Rhodia).

Preferred sulfosuccinates are, for example, the sodium, potassium and ammonium salts of bis(alkyl)sulfosuccinates, where the alkyl radicals are identical or different and contain 4 to 16 carbon atoms and are, for example, butyl, hexyl, octyl, such as 2-ethylhexyl, or decyl radicals, which may be straight-chain or branched. Particular preference is given to sodium di(C₄-C₁₀ alkyl)sulfosuccinate such as sodium di(2-ethylhexyl)sulfosuccinate.

If the herbicidal compositions according to the invention comprise sulfosuccinates e), their proportion by weight is generally 0.5 to 60% by weight, in particular 1 to 30% by weight.

Furthermore, customary additives (component f) may optionally also be contained in the herbicidal compositions according to the invention, for example thickeners and thixotropic agents, anti-drift agents, tackifiers, penetrants, preservatives, antifreeze agents, antioxidants, solubilizers, fillers, carriers, colorants, antifoams, evaporation inhibitors and agents which modify pH and viscosity.

Suitable thickeners and thixotropic agents are, for example:
1) modified natural silicates, such as chemically modified bentonites, hectorites, attapulgites, montmorillonites, smektites or other silicate minerals, such as Bentone® (Elementis), Attagel® (Engelhard), Agsorb® (Oil-Dri Corporation) or Hectorite® (Akzo Nobel),
2) synthetic silicates, such as silicates of the Sipernat®, Aerosil® or Durosil® series (Degussa), the CAB-O-SIL® series (Cabot) or the Van Gel series (R. T. Vanderbilt),
3) thickeners based on synthetic polymers, such as thickeners of the Thixin® or Thixatrol® series (Elementis),
4) thickeners based on natural polymers and natural oils, for example from the Thixin® or Thixatrol® series (Elementis).

Preferred thickeners and thixotropic agents are, for example, modified phylosilicates and thickeners based on synthetic polymers.

If the herbicidal compositions according to the invention comprise thickeners and thixotropic agents, their proportion by weight is generally from 0.1 to 5% by weight, in particular from 0.2 to 3% by weight.

Suitable agents which modify the pH are, for example, inorganic salts; these are preferably basic inorganic salts. These are to be understood as meaning salts which, in a 1% strength aqueous solution, have a pH>7, preferably weak basic salts having a pH between 7 and 11. Examples of such salts are carbonates, bicarbonates, hydroxides, oxides, hypochlorites and sulfites, preferably carbonates and bicarbonates. As cations, the inorganic salts preferably contain metal ions, in particular alkali metal, alkaline earth metal and transition metal ions, preferably alkali metal and alkaline earth metal ions, such as sodium, potassium, magnesium or calcium. Particularly preferred salts are alkali metal salts, in particular alkali metal carbonates and alkali metal bicarbonates, such as Na₂CO₃, K₂CO₃, NaHCO₃ and KHCO₃. The inorganic salts may be present on their own or as a mixture.

If the herbicidal compositions according to the invention comprise inorganic salts, their proportion by weight is generally from 0.01 to 20% by weight, preferably from 0.01 to 10% by weight, particularly preferably from 0.05 to 5% by weight.

Particular preference is given to herbicidal compositions according to the invention, comprising:
a) from 0.1 to 95% by weight, preferably from 5 to 50% by weight, of one or more herbicidally active compounds from the group of the dioxazinepyridyl-sulfonylureas, in particular those of the formula (I) and/or their salts,
b) from 5 to 99.9% by weight, preferably form 50 to 95% by weight, of one or more auxiliaries from the group of the fatty esters, fertilizers and surfactants,
c) optionally from 0.1 to 60% by weight, preferably from 2 to 40% by weight, of one or more safeners,
d) optionally from 0.5 to 50% by weight, preferably from 3 to 20% by weight, of one or more agrochemically active compounds different from a) and c),
e) optionally from 0.5 to 60% by weight, preferably from 1 to 30% by weight, of one or more sulfosuccinates,
f) optionally customary additives, in particular from 0.1 to 5% by weight, preferably from 0.2 to 3% by weight, of one or more thickeners and thixotropic agents.

In a preferred embodiment, the herbicidal composition according to the invention comprises:
a) one or more herbicidally active compounds of the formula (I) and/or their salts, preferably I-1 to I-145,
b) one or more auxiliaries from the group of the vegetable oils (preferably rapeseed oil methyl esters), ammonium salts (preferably ammonium sulfates, such as diammonium sulfate and ammonium nitrate) and surfactants (preferably polyethoxylated alcohols, polyethoxylated triglycerides containing fatty acid radicals, polyethylene oxide-polypropylene oxide block copolymers, alkylsulfonic acids and salts thereof, alkyloxylsulfonic acids and salts thereof and polyelectrolytes).

Particularly preferred examples which may be mentioned are herbicidal compositions according to the invention comprising the components listed below; however, this does not limit the invention. Here, Hasten=Hasten®, Rako-Binol=Rako-Binol®, Edenor=Edenor®MESU, Actirob=Actirob®B and Mero=Mero®.

Hasten+I-1, Rako-Binol+I-1, Edenor+I-1, Actirob B+I-1, Mero+I-1,

Hasten+I-2, Rako-Binol+I-2, Edenor+I-2, Actirob B+I-2, Mero 1-2,

Hasten+I-3, Rako-Binol+I-3, Edenor+I-3, Actirob B+I-3, Mero+I-3,

Hasten+I-4, Rako-Binol+I-4, Edenor+I-4, Actirob B+I-4, Mero+I-4,

Hasten+I-5, Rako-Binol+I-5, Edenor+I-5, Actirob B+I-5, Mero+I-5,

Hasten+I-6, Rako-Binol+I-6, Edenor+I-6, Actirob B+I-6, Mero+I-6,

Hasten+I-7, Rako-Binol+I-7, Edenor+I-7, Actirob B+I-7, Mero+I-7,

Hasten+I-8, Rako-Binol+I-8, Edenor+I-8, Actirob B+I-8, Mero+I-8,

Hasten+I-9, Rako-Binol+I-9, Edenor+I-9, Actirob B+I-9, Mero+I-9,

Hasten+I-10, Rako-Binol+I-10, Edenor+I-10, Actirob B+I-10, Mero+I-10,

Hasten+I-11, Rako-Binol+I-11, Edenor+I-11, Actirob B+I-11, Mero+I-11,

Hasten+I-12, Rako-Binol+I-12, Edenor+I-12, Actirob B+I-12, Mero+I-12,

Hasten+I-13, Rako-Binol+I-13, Edenor+I-13, Actirob B+I-13, Mero+I-13,

Hasten+I-14, Rako-Binol+I-14, Edenor+I-14, Actirob B+I-14, Mero+I-14,

Hasten+I-15, Rako-Binol+I-15, Edenor+I-15, Actirob B+I-15, Mero+I-15,

Hasten+I-16, Rako-Binol+I-16, Edenor+I-16, Actirob B+I-16, Mero+I-16,

Hasten+I-17, Rako-Binol+I-17, Edenor+I-17, Actirob B+I-17, Mero+I-17,

Hasten+I-18, Rako-Binol+I-18, Edenor+I-18, Actirob B+I-18, Mero+I-18,

Hasten+I-19, Rako-Binol+I-19, Edenor+I-19, Actirob B+I-19, Mero+I-19,

Hasten+I-20, Rako-Binol+I-20, Edenor+I-20, Actirob B+I-20, Mero+I-20,

Hasten+I-21, Rako-Binol+I-21, Edenor+I-21, Actirob B+I-21, Mero+I-21,

Hasten+I-22, Rako-Binol+I-22, Edenor+I-22, Actirob B+I-22, Mero+I-22,

Hasten+I-23, Rako-Binol+I-23, Edenor+I-23, Actirob B+I-23, Mero+I-23,

Hasten+I-24, Rako-Binol+I-24, Edenor+I-24, Actirob B+I-24, Mero+I-24,

Hasten+I-25, Rako-Binol+I-25, Edenor+I-25, Actirob B+I-25, Mero+I-25,

Hasten+I-26, Rako-Binol+I-26, Edenor+I-26, Actirob B+I-26, Mero+I-26,

Hasten+I-27, Rako-Binol+I-27, Edenor+I-27, Actirob B+I-27, Mero+I-27,

Hasten+I-28, Rako-Binol+I-28, Edenor+I-28, Actirob B+I-28, Mero+I-28,

Hasten+I-29, Rako-Binol+I-29, Edenor+I-29, Actirob B+I-29, Mero+I-29,

Hasten+I-30, Rako-Binol+I-30, Edenor+I-30, Actirob B+I-30, Mero+I-30,

Hasten+I-31, Rako-Binol+I-31, Edenor+I-31, Actirob B+I-31, Mero+I-31,

Hasten+I-32, Rako-Binol+I-32, Edenor+I-32, Actirob B+I-32, Mero+I-32,

Hasten+I-33, Rako-Binol+I-33, Edenor+I-33, Actirob B+I-33, Mero+I-33,

Hasten+I-34, Rako-Binol+I-34, Edenor+I-34, Actirob B+I-34, Mero+I-34,

Hasten+I-35, Rako-Binol+I-35, Edenor+I-35, Actirob B+I-35, Mero+I-35,

Hasten+I-36, Rako-Binol+I-36, Edenor+I-36, Actirob B+I-36, Mero+I-36,

Hasten+I-37, Rako-Binol+I-37, Edenor+I-37, Actirob B+I-37, Mero+I-37,

Hasten+I-38, Rako-Binol+I-38, Edenor+I-38, Actirob B+I-38, Mero+I-38,

Hasten+I-39, Rako-Binol+I-39, Edenor+I-39, Actirob B+I-39, Mero+I-39,

Hasten+I-40, Rako-Binol+I-40, Edenor+I-40, Actirob B+I-40, Mero+I-40,

Hasten+I-41, Rako-Binol+I-41, Edenor+I-41, Actirob B+I-41, Mero+I-41,

Hasten+I-42, Rako-Binol+I-42, Edenor+I-42, Actirob B+I-42, Mero+I-42,

Hasten+I-43, Rako-Binol+I-43, Edenor+I-43, Actirob B+I-43, Mero+I-43,

Hasten+I-44, Rako-Binol+I-44, Edenor+I-44, Actirob B+I-44, Mero+I-44,

Hasten+I-45, Rako-Binol+I-45, Edenor+I-45, Actirob B+I-45, Mero+I-45,

Hasten+I-46, Rako-Binol+I-46, Edenor+I-46, Actirob B+I-46, Mero+I-46,

Hasten+I-47, Rako-Binol+I-47, Edenor+I-47, Actirob B+I-47, Mero+I-47,

Hasten+I-48, Rako-Binol+I-48, Edenor+I-48, Actirob B+I-48, Mero+I-48,

Hasten+I-49, Rako-Binol+I-49, Edenor+I-49, Actirob B+I-49, Mero+I-49,

Hasten+I-50, Rako-Binol+I-50, Edenor+I-50, Actirob B+I-50, Mero+I-50,

Hasten+I-51, Rako-Binol+I-51, Edenor+I-51, Actirob B+I-51, Mero+I-51,

Hasten+I-52, Rako-Binol+I-52, Edenor+I-52, Actirob B+I-52, Mero+I-52,

Hasten+I-53, Rako-Binol+I-53, Edenor+I-53, Actirob B+I-53, Mero+I-53,

Hasten+I-54, Rako-Binol+I-54, Edenor+I-54, Actirob B+I-54, Mero+I-54,

Hasten+I-55, Rako-Binol+I-55, Edenor+I-55, Actirob B+I-55, Mero+I-55,

Hasten+I-56, Rako-Binol+I-56, Edenor+I-56, Actirob B+I-56, Mero+I-56,

Hasten+I-57, Rako-Binol+I-57, Edenor+I-57, Actirob B+I-57, Mero+I-57,

Hasten+I-58, Rako-Binol+I-58, Edenor+I-58, Actirob B+I-58, Mero+I-58,

Hasten+I-59, Rako-Binol+I-59, Edenor+I-59, Actirob B+I-59, Mero+I-59,

Hasten+I-60, Rako-Binol+I-60, Edenor+I-60, Actirob B+I-60, Mero+I-60,

Hasten+I-61, Rako-Binol+I-61, Edenor+I-61, Actirob B+I-61, Mero+I-61,

Hasten+I-62, Rako-Binol+I-62, Edenor+I-62, Actirob B+I-62, Mero+I-62,

Hasten+I-63, Rako-Binol+I-63, Edenor+I-63, Actirob B+I-63, Mero+I-63,

Hasten+I-64, Rako-Binol+I-64, Edenor+I-64, Actirob B+I-64, Mero+I-64,

Hasten+I-65, Rako-Binol+I-65, Edenor+I-65, Actirob B+I-65, Mero+I-65,

Hasten+I-66, Rako-Binol+I-66, Edenor+I-66, Actirob B+I-66, Mero+I-66,

Hasten+I-67, Rako-Binol+I-67, Edenor+I-67, Actirob B+I-67, Mero+I-67,

Hasten+I-68, Rako-Binol+I-68, Edenor+I-68, Actirob B+I-68, Mero+I-68,

Hasten+I-69, Rako-Binol+I-69, Edenor+I-69, Actirob B+I-69, Mero+I-69,

Hasten+I-70, Rako-Binol+I-70, Edenor+I-70, Actirob B+I-70, Mero+I-70,

Hasten+I-71, Rako-Binol+I-71, Edenor+I-71, Actirob B+I-71, Mero+I-71,

Hasten+I-72, Rako-Binol+I-72, Edenor+I-72, Actirob B+I-72, Mero+I-72,

Hasten+I-73, Rako-Binol+I-73, Edenor+I-73, Actirob B+I-73, Mero+I-73,

Hasten+I-74, Rako-Binol+I-74, Edenor+I-74, Actirob B+I-74, Mero+I-74,

Hasten+I-75, Rako-Binol+I-75, Edenor+I-75, Actirob B+I-75, Mero+I-75,

Hasten+I-76, Rako-Binol+I-76, Edenor+I-76, Actirob B+I-76, Mero+I-76,

Hasten+I-77, Rako-Binol+I-77, Edenor+I-77, Actirob B+I-77, Mero+I-77,

Hasten+I-78, Rako-Binol+I-78, Edenor+I-78, Actirob B+I-78, Mero+I-78,

Hasten+I-79, Rako-Binol+I-79, Edenor+I-79, Actirob B+I-79, Mero+I-79,

Hasten+I-80, Rako-Binol+I-80, Edenor+I-80, Actirob B+I-80, Mero+I-80,

Hasten+I-81, Rako-Binol+I-81, Edenor+I-81, Actirob B+I-81, Mero+I-81,

Hasten+I-82, Rako-Binol+I-82, Edenor+I-82, Actirob B+I-82, Mero+I-82,

Hasten+I-83, Rako-Binol+I-83, Edenor+I-83, Actirob B+I-83, Mero+I-83,

Hasten+I-84, Rako-Binol+I-84, Edenor+I-84, Actirob B+I-84, Mero+I-84,

Hasten+I-85, Rako-Binol+I-85, Edenor+I-85, Actirob B+I-85, Mero+I-85,

Hasten+I-86, Rako-Binol+I-86, Edenor+I-86, Actirob B+I-86, Mero+I-86,

Hasten+I-87, Rako-Binol+I-87, Edenor+I-87, Actirob B+I-87, Mero+I-87,

Hasten+I-88, Rako-Binol+I-88, Edenor+I-88, Actirob B+I-88, Mero+I-88,

Hasten+I-89, Rako-Binol+I-89, Edenor+I-89, Actirob B+I-89, Mero+I-89,

Hasten+I-90, Rako-Binol+I-90, Edenor+I-90, Actirob B+I-90, Mero+I-90,

Hasten+I-91, Rako-Binol+I-91, Edenor+I-91, Actirob B+I-91, Mero+I-91,

Hasten+I-92, Rako-Binol+I-92, Edenor+I-92, Actirob B+I-92, Mero+I-92,

Hasten+I-93, Rako-Binol+I-93, Edenor+I-93, Actirob B+I-93, Mero+I-93,

Hasten+I-94, Rako-Binol+I-94, Edenor+I-94, Actirob B+I-94, Mero+I-94,

Hasten+I-95, Rako-Binol+I-95, Edenor+I-95, Actirob B+I-95, Mero+I-95,

Hasten+I-96, Rako-Binol+I-96, Edenor+I-96, Actirob B+I-96, Mero+I-96,

Hasten+I-97, Rako-Binol+I-97, Edenor+I-97, Actirob B+I-97, Mero+I-97,

Hasten+I-98, Rako-Binol+I-98, Edenor+I-98, Actirob B+I-98, Mero+I-98,

Hasten+I-99, Rako-Binol+I-99, Edenor+I-99, Actirob B+I-99, Mero+I-99,

Hasten+I-100, Rako-Binol+I-100, Edenor+I-100, Actirob B+I-100, Mero+I-100,

Hasten+I-101, Rako-Binol+I-101, Edenor+I-101, Actirob B+I-101, Mero+I-101,

Hasten+I-102, Rako-Binol+I-102, Edenor+I-102, Actirob B+I-102, Mero+I-102,

Hasten+I-103, Rako-Binol+I-103, Edenor+I-103, Actirob B+I-103, Mero+I-103,

Hasten+I-104, Rako-Binol+I-104, Edenor+I-104, Actirob B+I-104, Mero+I-104,

Hasten+I-105, Rako-Binol+I-105, Edenor+I-105, Actirob B+I-105, Mero+I-105,

Hasten+I-106, Rako-Binol+I-106, Edenor+I-106, Actirob B+I-106, Mero+I-106,

Hasten+I-107, Rako-Binol+I-107, Edenor+I-107, Actirob B+I-107, Mero+I-107,

Hasten+I-108, Rako-Binol+I-108, Edenor+I-108, Actirob B+I-108, Mero+I-108,

Hasten+I-109, Rako-Binol+I-109, Edenor+I-109, Actirob B+I-109, Mero+I-109,

Hasten+I-110, Rako-Binol+I-110, Edenor+I-110, Actirob B+I-110, Mero+I-110,

Hasten+I-111, Rako-Binol+I-111, Edenor+I-111, Actirob B+I-111, Mero+I-111,

Hasten+I-112, Rako-Binol+I-112, Edenor+I-112, Actirob B+I-112, Mero+I-112,

Hasten+I-113, Rako-Binol+I-113, Edenor+I-113, Actirob B+I-113, Mero+I-113,

Hasten+I-114, Rako-Binol+I-114, Edenor+I-114, Actirob B+I-114, Mero+I-114,

Hasten+I-115, Rako-Binol+I-115, Edenor+I-115, Actirob B+I-115, Mero+I-115,

Hasten+I-116, Rako-Binol+I-116, Edenor+I-116, Actirob B+I-116, Mero+I-116,

Hasten+I-117, Rako-Binol+I-117, Edenor+I-117, Actirob B+I-117, Mero+I-117,

Hasten+I-118, Rako-Binol+I-118, Edenor+I-118, Actirob B+I-118, Mero+I-118,

Hasten+I-119, Rako-Binol+I-119, Edenor+I-119, Actirob B+I-119, Mero+I-119,

Hasten+I-120, Rako-Binol+I-120, Edenor+I-120, Actirob B+I-120, Mero+I-120,

Hasten+I-121, Rako-Binol+I-121, Edenor+I-121, Actirob B+I-121, Mero+I-121,

Hasten+I-122, Rako-Binol+I-122, Edenor+I-122, Actirob B+I-122, Mero+I-122,

Hasten+I-123, Rako-Binol+I-123, Edenor+I-123, Actirob B+I-123, Mero+I-123,

Hasten+I-124, Rako-Binol+I-124, Edenor+I-124, Actirob B+I-124, Mero+I-124,

Hasten+I-125, Rako-Binol+I-125, Edenor+I-125, Actirob B+I-125, Mero+I-125,

Hasten+I-126, Rako-Binol+I-126, Edenor+I-126, Actirob B+I-126, Mero+I-126,

Hasten+I-127, Rako-Binol+I-127, Edenor+I-127, Actirob B+I-127, Mero+I-127,

Hasten+I-128, Rako-Binol+I-128, Edenor+I-128, Actirob B+I-128, Mero+I-128,

Hasten+I-129, Rako-Binol+I-129, Edenor+I-129, Actirob B+I-129, Mero+I-129,

Hasten+I-130, Rako-Binol+I-130, Edenor+I-130, Actirob B+I-130, Mero+I-130,

Hasten+I-131, Rako-Binol+I-131, Edenor+I-131, Actirob B+I-131, Mero+I-131,

Hasten+I-132, Rako-Binol+I-132, Edenor+I-132, Actirob B+I-132, Mero+I-132,

Hasten+I-133, Rako-Binol+I-133, Edenor+I-133, Actirob B+I-133, Mero+I-133,

Hasten+I-134, Rako-Binol+I-134, Edenor+I-134, Actirob B+I-134, Mero+I-134,

Hasten+I-135, Rako-Binol+I-135, Edenor+I-135, Actirob B+I-135, Mero+I-135,

Hasten+I-136, Rako-Binol+I-136, Edenor+I-136, Actirob B+I-136, Mero+I-136,

Hasten+I-137, Rako-Binol+I-137, Edenor+I-137, Actirob B+I-137, Mero+I-137,

Hasten+I-138, Rako-Binol+I-138, Edenor+I-138, Actirob B+I-138, Mero+I-138,

Hasten+I-139, Rako-Binol+I-139, Edenor+I-139, Actirob B+I-139, Mero+I-139,

Hasten+I-140, Rako-Binol+I-140, Edenor+I-140, Actirob B+I-140, Mero+I-140,

Hasten+I-141, Rako-Binol+I-141, Edenor+I-141, Actirob B+I-141, Mero+I-141,

Hasten+I-142, Rako-Binol+I-142, Edenor+I-142, Actirob B+I-142, Mero+I-142,

Hasten+I-143, Rako-Binol+I-143, Edenor+I-143, Actirob B+I-143, Mero+I-143,

Hasten+I-144, Rako-Binol+I-144, Edenor+I-144, Actirob B+I-144, Mero+I-144,

Hasten+I-145, Rako-Binol+I-145, Edenor+I-145, Actirob B+I-145, Mero+I-145,

Hasten+diammonium sulfate+I-1, Rako-Binol+diammonium sulfate+I-1, Edenor+diammonium sulfate+I-1, Actirob B+diammonium sulfate+I-1, Mero+diammonium sulfate+I-1,

Hasten+diammonium sulfate+I-2, Rako-Binol+diammonium sulfate+I-2, Edenor+diammonium sulfate+I-2, Actirob B+diammonium sulfate+I-2, Mero+diammonium sulfate I-2,

Hasten+diammonium sulfate+I-3, Rako-Binol+diammonium sulfate+I-3, Edenor+diammonium sulfate+I-3, Actirob B+diammonium sulfate+I-3, Mero+diammonium sulfate+I-3,

Hasten+diammonium sulfate+I-4, Rako-Binol+diammonium sulfate+I-4, Edenor+diammonium sulfate+I-4, Actirob B+diammonium sulfate+I-4, Mero+diammonium sulfate+I-4,

Hasten+diammonium sulfate+I-5, Rako-Binol+diammonium sulfate+I-5, Edenor+diammonium sulfate+I-5, Actirob B+diammonium sulfate+I-5, Mero+diammonium sulfate+I-5,

Hasten+diammonium sulfate+I-6, Rako-Binol+diammonium sulfate+I-6, Edenor+diammonium sulfate+I-6, Actirob B+diammonium sulfate+I-6, Mero+diammonium sulfate+I-6,

Hasten+diammonium sulfate+I-7, Rako-Binol+diammonium sulfate+I-7, Edenor+diammonium sulfate+I-7, Actirob B+diammonium sulfate+I-7, Mero+diammonium sulfate+I-7,

Hasten+diammonium sulfate+I-8, Rako-Binol+diammonium sulfate+I-8, Edenor+diammonium sulfate+I-8, Actirob B+diammonium sulfate+I-8, Mero+diammonium sulfate+I-8,

Hasten+diammonium sulfate+I-9, Rako-Binol+diammonium sulfate+I-9, Edenor+diammonium sulfate+I-9, Actirob B+diammonium sulfate+I-9, Mero+diammonium sulfate+I-9,

Hasten+diammonium sulfate+I-10, Rako-Binol+diammonium sulfate+I-10,

Edenor+diammonium sulfate+I-10, Actirob B+diammonium sulfate+I-10, Mero+diammonium sulfate+I-10, Hasten+diammonium sulfate+I-11, Rako-Binol+diammonium sulfate+I-11, Edenor+diammonium sulfate+I-11, Actirob B+diammonium sulfate+I-11, Mero+diammonium sulfate+I-11, Hasten+diammonium sulfate+I-12, Rako-Binol+diammonium sulfate+I-12, Edenor+diammonium sulfate+I-12, Actirob B+diammonium sulfate+I-12, Mero+diammonium sulfate+I-12, Hasten+diammonium sulfate+I-13, Rako-Binol+diammonium sulfate+I-13, Edenor+diammonium sulfate+I-13, Actirob B+diammonium sulfate+I-13, Mero+diammonium sulfate+I-13, Hasten+diammonium sulfate+I-14, Rako-Binol+diammonium sulfate+I-14, Edenor+diammonium sulfate+I-14, Actirob B+diammonium sulfate+I-14, Mero+diammonium sulfate+I-14, Hasten+diammonium sulfate+I-15, Rako-Binol+diammonium sulfate+I-15, Edenor+diammonium sulfate+I-15, Actirob B+diammonium sulfate+I-15, Mero+diammonium sulfate+I-15, Hasten+diammonium sulfate+I-16, Rako-Binol+diammonium sulfate+I-16, Edenor+diammonium sulfate+I-16, Actirob B+diammonium sulfate+I-16, Mero+diammonium sulfate+I-16, Hasten+diammonium sulfate+I-17, Rako-Binol+diammonium sulfate+I-17, Edenor+diammonium sulfate+I-17, Actirob B+diammonium sulfate+I-17, Mero+diammonium sulfate+I-17, Hasten+diammonium sulfate+I-18, Rako-Binol+diammonium sulfate+I-18, Edenor+diammonium sulfate+I-18, Actirob B +diammonium sulfate+I-18, Mero+diammonium sulfate+I-18, Hasten+diammonium sulfate+I-19, Rako-Binol+diammonium sulfate+I-19, Edenor+diammonium sulfate+I-19, Actirob B+diammonium sulfate+I-19, Mero+diammonium sulfate+I-19, Hasten+diammonium sulfate+I-20, Rako-Binol+diammonium sulfate+I-20, Edenor+diammonium sulfate+I-20, Actirob B+diammonium sulfate+I-20, Mero+diammonium sulfate+I-20, Hasten+diammonium sulfate+I-21, Rako-Binol+diammonium sulfate+I-21, Edenor+diammonium sulfate+I-21, Actirob B+diammonium sulfate+I-21, Mero+diammonium sulfate+I-21, Hasten+diammonium sulfate+I-22, Rako-Binol+diammonium sulfate+I-22, Edenor+diammonium sulfate+I-22, Actirob B+diammonium sulfate+I-22, Mero+diammonium sulfate+I-22, Hasten+diammonium sulfate+I-23, Rako-Binol+diammonium sulfate+I-23, Edenor+diammonium sulfate+I-23, Actirob B+diammonium sulfate+I-23, Mero+diammonium sulfate+I-23, Hasten+diammonium sulfate+I-24, Rako-Binol+diammonium sulfate+I-24, Edenor+diammonium sulfate+I-24, Actirob B+diammonium sulfate+I-24, Mero+diammonium sulfate+I-24, Hasten+diammonium sulfate+I-25, Rako-Binol+diammonium sulfate+I-25, Edenor+diammonium sulfate+I-25, Actirob B+diammonium sulfate+I-25, Mero+diammonium sulfate+I-25, Hasten+diammonium sulfate+I-26, Rako-Binol+diammonium sulfate+I-26, Edenor+diammonium sulfate+I-26, Actirob B+diammonium sulfate+I-26, Mero+diammonium sulfate+I-26, Hasten+diammonium sulfate+I-27, Rako-Binol+diammonium sulfate+I-27, Edenor+diammonium sulfate+I-27, Actirob B+diammonium sulfate+I-27, Mero+diammonium sulfate+I-27, Hasten+diammonium sulfate+I-28, Rako-Binol+diammonium sulfate+I-28, Edenor+diammonium sulfate+I-28, Actirob B+diammonium sulfate+I-28, Mero+diammonium sulfate+I-28, Hasten+diammonium sulfate+I-29, Rako-Binol+diammonium sulfate+I-29, Edenor+diammonium sulfate+I-29, Actirob B+diammonium sulfate+I-29, Mero+diammonium sulfate+I-29, Hasten+diammonium sulfate+I-30, Rako-Binol+diammonium sulfate+I-30, Edenor+diammonium sulfate+I-30, Actirob B+diammonium sulfate+I-30, Mero+diammonium sulfate+I-30, Hasten+diammonium sulfate+I-31, Rako-Binol+diammonium sulfate+I-31, Edenor+diammonium sulfate+I-31, Actirob B+diammonium sulfate+I-31, Mero+diammonium sulfate+I-31, Hasten+diammonium sulfate+I-32, Rako-Binol+diammonium sulfate+I-32, Edenor+diammonium sulfate+I-32, Actirob B+diammonium sulfate+I-32, Mero+diammonium sulfate+I-32, Hasten+diammonium sulfate+I-33, Rako-Binol+diammonium sulfate+I-33, Edenor+diammonium sulfate+I-33, Actirob B+diammonium sulfate+I-33, Mero+diammonium sulfate+I-33, Hasten+diammonium sulfate+I-34, Rako-Binol+diammonium sulfate+I-34, Edenor+diammonium sulfate+I-34, Actirob B+diammonium sulfate+I-34, Mero+diammonium sulfate+I-34, Hasten+diammonium sulfate+I-35, Rako-Binol+diammonium sulfate+I-35, Edenor+diammonium sulfate+I-35, Actirob B+diammonium sulfate+I-35, Mero+diammonium sulfate+I-35, Hasten+diammonium sulfate+I-36, Rako-Binol+diammonium sulfate+I-36, Edenor+diammonium sulfate+I-36, Actirob B+diammonium sulfate+I-36, Mero+diammonium sulfate+I-36, Hasten+diammonium sulfate+I-37, Rako-Binol+diammonium sulfate+I-37, Edenor+diammonium sulfate+I-37, Actirob B+diammonium sulfate+I-37, Mero+diammonium sulfate+I-37, Hasten+diammonium sulfate+I-38, Rako-Binol+diammonium sulfate+I-38, Edenor+diammonium sulfate+I-38, Actirob B+diammonium sulfate+I-38, Mero+diammonium sulfate+I-38, Hasten+diammonium sulfate+I-39, Rako-Binol+diammonium sulfate+I-39, Edenor+diammonium sulfate+I-39, Actirob B+diammonium sulfate+I-39, Mero+diammonium sulfate+I-39, Hasten+diammonium sulfate+I-40, Rako-Binol+diammonium sulfate+I-40, Edenor+diammonium sulfate+I-40, Actirob B+diammonium sulfate+I-40, Mero+diammonium sulfate+I-40, Hasten+diammonium sulfate+I-41, Rako-Binol+diammonium sulfate+I-41, Edenor+diammonium sulfate+I-41, Actirob B+diammonium sulfate+I-41, Mero+diammonium-sulfate+I-41, Hasten+diammonium sulfate+I-42, Rako-Binol+diammonium sulfate+I-42, Edenor+diammonium sulfate+I-42, Actirob B+diammonium sulfate+I-42, Mero+diammonium sulfate+I-42, Hasten+diammonium sulfate+I-43, Rako-Binol+diammonium sulfate+I-43, Edenor+diammonium sulfate+I-43, Actirob B+diammonium sulfate+I-43, Mero+diammonium sulfate+I-43, Hasten+diammonium sulfate+I-44, Rako-Binol+diammonium sulfate+I-44, Edenor+diammonium sulfate+I-44, Actirob B+diammonium sulfate+I-44, Mero+diammonium sulfate+I-44, Hasten+diammonium sulfate+I-45, Rako-Binol+diammonium sulfate+I-45, Edenor+diammonium sulfate+I-45, Actirob B+diammonium sulfate+I-45, Mero+diammonium sulfate+I-45, Hasten+diammonium sulfate+I-46, Rako-Binol+diammonium sulfate+I-46, Edenor+diammonium sulfate+I-46, Actirob B+diammonium sulfate+I-46, Mero+diammonium sulfate+I-46, Hasten+diammonium sulfate+I-47, Rako-Binol+diammonium sulfate+I-47, Edenor+diammonium sulfate+I-47, Actirob B+diammonium sulfate+I-47, Mero+diammonium sulfate+I-47, Hasten+diammonium sulfate+I-48, Rako-Binol+diammonium sulfate+I-48, Edenor+diammonium sulfate+I-48, Actirob B+diammonium sulfate+I-48, Mero+diammonium sulfate+I-48, Hasten+diammonium sulfate+I-49, Rako-Binol+diammonium sulfate+I-49, Edenor+diammonium sulfate+I-49, Actirob B+diammonium sulfate+I-49, Mero+diammonium sulfate+I-49, Hasten+diammonium sulfate+I-50, Rako-Binol+diammonium sulfate+I-50, Edenor+diammonium sulfate+I-50, Actirob B+diammonium sulfate+I-50, Mero+diammonium sulfate+I-50, Hasten+diammonium sulfate+I-51, Rako-Binol+diammonium sulfate+I-51, Edenor+diammonium sulfate+I-51, Actirob B+diammonium sulfate+I-51, Mero+diammonium sulfate+I-51, Hasten+diammonium sulfate+I-52, Rako-Binol+diammonium sulfate+I-52, Edenor+diammonium sulfate+I-52, Actirob B+diammonium sulfate+I-52, Mero+diammonium sulfate+I-52, Hasten+diammonium sulfate+I-53, Rako-Binol+diammonium sulfate+I-53, Edenor+diammonium sulfate+I-53, Actirob B+diammonium sulfate+I-53, Mero+diammonium sulfate+I-53, Hasten+diammonium sulfate+I-54, Rako-Binol+diammonium sulfate+I-54, Edenor+diammonium sulfate+I-54, Actirob B+diammonium sulfate+I-54, Mero+diammonium sulfate+I-54, Hasten+diammonium sulfate+I-55, Rako-Binol+diammonium sulfate+I-55, Edenor+diammonium sulfate+I-55, Actirob B+diammonium sulfate+I-55, Mero+diammonium sulfate+I-55, Hasten+diammonium sulfate+I-56, Rako-Binol+diammonium sulfate+I-56, Edenor+diammonium sulfate+I-56, Actirob B+diammonium sulfate+I-56, Mero+diammonium sulfate+I-56, Hasten+diammonium sulfate+I-57, Rako-Binol+diammonium sulfate+I-57, Edenor+diammonium sulfate+I-57, Actirob B+diammonium sulfate+I-57, Mero+diammonium sulfate+I-57, Hasten+diammonium sulfate+I-58, Rako-Binol+diammonium sulfate+I-58, Edenor+diammonium sulfate+I-58, Actirob B+diammonium sulfate+I-58, Mero+diammonium sulfate+I-58, Hasten+diammonium sulfate+I-59, Rako-Binol+diammonium sulfate+I-59, Edenor+diammonium sulfate+I-59, Actirob B+diammonium sulfate+I-59, Mero+diammonium sulfate+I-59, Hasten+diammonium sulfate+I-60, Rako-Binol+diammonium sulfate+I-60, Edenor+diammonium sulfate+I-60, Actirob B+diammonium sulfate+I-60, Mero+diammonium sulfate+I-60, Hasten+diammonium sulfate+I-61, Rako-Binol+diammonium sulfate+I-61, Edenor+diammonium sulfate+I-61, Actirob B+diammonium sulfate+I-61, Mero+diammonium sulfate+I-61, Hasten+diammonium sulfate+I-62, Rako-Binol+diammonium sulfate+I-62, Edenor+diammonium sulfate+I-62, Actirob B+diammonium sulfate+I-62, Mero+diammonium sulfate+I-62, Hasten+diammonium sulfate+I-63, Rako-Binol+diammonium sulfate+I-63, Edenor+diammonium sulfate+I-63, Actirob B+diammonium sulfate+I-63, Mero+diammonium sulfate+I-63, Hasten+diammonium sulfate+I-64, Rako-Binol+diammonium sulfate+I-64, Edenor+diammonium sulfate+I-64, Actirob B+diammonium sulfate+I-64, Mero+diammonium sulfate+I-64, Hasten+diammonium sulfate+I-65, Rako-Binol+diammonium sulfate+I-65, Edenor+diammonium sulfate+I-65, Actirob B+diammonium sulfate+I-65, Mero+diammonium sulfate+I-65, Hasten+diammonium sulfate+I-66, Rako-Binol+diammonium sulfate+I-66, Edenor+diammonium sulfate+I-66, Actirob B+diammonium sulfate+I-66, Mero+diammonium sulfate+I-66, Hasten+diammonium sulfate+I-67, Rako-Binol+diammonium sulfate+I-67, Edenor+diammonium sulfate+I-67, Actirob B+diammonium sulfate+I-67, Mero+diammonium sulfate+I-67, Hasten+diammonium sulfate+I-68, Rako-Binol+diammonium sulfate+I-68, Edenor+diammonium sulfate+I-68, Actirob B+diammonium sulfate+I-68, Mero+diammonium sulfate+I-68, Hasten+diammonium sulfate+I-69, Rako-Binol+diammonium sulfate+I-69, Edenor+diammonium sulfate+I-69, Actirob B+diammonium sulfate+I-69, Mero+diammonium sulfate+I-69, Hasten+diammonium sulfate+I-70, Rako-Binol+diammonium sulfate+I-70, Edenor+diammonium sulfate+I-70, Actirob B+diammonium sulfate+I-70, Mero+diammonium sulfate+I-70, Hasten+diammonium sulfate+I-71, Rako-Binol+diammonium sulfate+I-71, Edenor+diammonium sulfate+I-71, Actirob B+diammonium sulfate+I-71, Mero+diammonium sulfate+I-71, Hasten+diammonium sulfate+I-72, Rako-Binol+diammonium sulfate+I-72, Edenor+diammonium sulfate+I-72, Actirob B+diammonium sulfate+I-72, Mero+diammonium sulfate+I-72, Hasten+diammonium sulfate+I-73, Rako-Binol+diammonium sulfate+I-73, Edenor+diammonium sulfate+I-73, Actirob B+diammonium sulfate+I-73, Mero+diammonium sulfate+I-73, Hasten+diammonium sulfate+I-74, Rako-Binol+diammonium sulfate+I-74, Edenor+diammonium sulfate+I-74, Actirob B+diammonium sulfate+I-74, Mero+diammonium sulfate+I-74, Hasten+diammonium sulfate+I-75, Rako-Binol+diammonium sulfate+I-75, Edenor+diammonium sulfate+I-75, Actirob B+diammonium sulfate+I-75, Mero+diammonium sulfate+I-75, Hasten,+diammonium sulfate+I-76, Rako-Binol+diammonium sulfate+I-76, Edenor+diammonium sulfate+I-76, Actirob B+diammonium sulfate+I-76, Mero+diammonium sulfate+I-76, Hasten+diammonium sulfate+I-77, Rako-Binol+diammonium sulfate+I-77, Edenor+diammonium sulfate+I-77, Actirob B+diammonium sulfate+I-77, Mero+diammonium sulfate+I-77, Hasten+diammonium sulfate+I-78, Rako-Binol+diammonium sulfate+I-78, Edenor+diammonium sulfate+I-78, Actirob B+diammonium sulfate+I-78, Mero+diammonium sulfate+I-78, Hasten+diammonium sulfate+I-79, Rako-Binol+diammonium sulfate+I-79, Edenor+diammonium sulfate+I-79, Actirob B+diammonium sulfate+I-79, Mero+diammonium sulfate+I-79, Hasten+diammonium sulfate+I-80, Rako-Binol+diammonium sulfate+I-80, Edenor+diammonium sulfate+I-80, Actirob B+diammonium sulfate+I-80, Mero+diammonium sulfate+I-80, Hasten+diammonium sulfate+I-81, Rako-Binol+diammonium sulfate+I-81, Edenor+diammonium sulfate+I-81, Actirob B+diammonium sulfate+I-81, Mero+diammonium sulfate+I-81, Hasten+diammonium sulfate+I-82, Rako-Binol+diammonium sulfate+I-82, Edenor+diammonium sulfate+I-82, Actirob B+diammonium sulfate+I-82, Mero+diammonium sulfate+I-82, Hasten+diammonium sulfate+I-83, Rako-Binol+diammonium sulfate+I-83, Edenor+diammonium sulfate+I-83, Actirob B+diammonium sulfate+I-83, Mero+diammonium sulfate+I-83, Hasten+diammonium sulfate+I-84, Rako-Binol+diammonium sulfate+I-84, Edenor+diammonium sulfate+I-84, Actirob B+diammonium sulfate+I-84, Mero+diammonium sulfate+I-84, Hasten+diammonium sulfate+I-85, Rako-Binol+diammonium sulfate+I-85, Edenor+diammonium sulfate+I-85, Actirob B+diammonium sulfate+I-85, Mero+diammonium sulfate+I-85, Hasten+diammonium sulfate+I-86, Rako-Binol+diammonium sulfate+I-86, Edenor+diammonium sulfate+I-86, Actirob B+diammonium sulfate+I-86, Mero+diammonium sulfate+I-86, Hasten+diammonium sulfate+I-87, Rako-Binol+diammonium sulfate+I-87, Edenor+diammonium sulfate+I-87, Actirob B+diammonium sulfate+I-87, Mero+diammonium sulfate+I-87, Hasten+diammonium sulfate+I-88, Rako-Binol+diammonium sulfate+I-88, Edenor+diammonium sulfate+I-88, Actirob B+diammonium sulfate+I-88, Mero+diammonium sulfate+I-88, Hasten+diammonium sulfate+I-89, Rako-Binol+diammonium sulfate+I-89, Edenor+diammonium sulfate+I-89, Actirob B+diammonium sulfate+I-89, Mero+diammonium sulfate+I-89, Hasten+diammonium sulfate+I-90, Rako-Binol+diammonium sulfate+I-90, Edenor+diammonium sulfate+I-90, Actirob B+diammonium sulfate+I-90, Mero+diammonium sulfate+I-90, Hasten+diammonium sulfate+I-91, Rako-Binol+diammonium sulfate+I-91, Edenor+diammonium sulfate+I-91, Actirob B+diammonium sulfate+I-91, Mero+diammonium sulfate+I-91, Hasten+diammonium sulfate+I-92, Rako-Binol+diammonium sulfate+I-92, Edenor+diammonium sulfate+I-92, Actirob B+diammonium sulfate+I-92, Mero+diammonium sulfate+I-92, Hasten+diammonium sulfate+I-93, Rako-Binol+diammonium sulfate+I-93, Edenor+diammonium sulfate+I-93, Actirob B+diammonium sulfate+I-93, Mero+diammonium sulfate+I-93, Hasten+diammonium sulfate+I-94, Rako-Binol+diammonium sulfate+I-94, Edenor+diammonium sulfate+I-94, Actirob B+diammonium sulfate+I-94, Mero+diammonium sulfate+I-94, Hasten+diammonium sulfate+I-95, Rako-Binol+diammonium sulfate+I-95, Edenor+diammonium sulfate+I-95, Actirob B+diammonium sulfate+I-95, Mero+diammonium sulfate+I-95, Hasten+diammonium sulfate+I-96, Rako-Binol+diammonium sulfate+I-96, Edenor+diammonium sulfate+I-96, Actirob B+diammonium sulfate+I-96, Mero+diammonium sulfate+I-96, Hasten+diammonium sulfate+I-97, Rako-Binol+diammonium sulfate+I-97, Edenor+diammonium sulfate+I-97, Actirob B+diammonium sulfate+I-97, Mero+diammonium sulfate+I-97, Hasten+diammonium sulfate+I-98, Rako-Binol+diammonium sulfate+I-98, Edenor+diammonium sulfate+I-98, Actirob B+diammonium sulfate+I-98, Mero+diammonium sulfate+I-98, Hasten+diammonium sulfate+I-99, Rako-Binol+diammonium sulfate+I-99, Edenor+diammonium sulfate+I-99, Actirob B+diammonium sulfate+I-99, Mero+diammonium sulfate+I-99, Hasten+diammonium sulfate+I-100, Rako-Binol+diammonium sulfate+I-100, Edenor+diammonium sulfate+I-100, Actirob B+diammonium sulfate+I-100, Mero+diammonium sulfate+I-100, Hasten+diammonium sulfate+I-101, Rako-Binol+diammonium sulfate+I-101, Edenor+diammonium sulfate+I-101, Actirob B+diammonium sulfate+I-101, Mero+diammonium sulfate+I-101, Hasten+diammonium sulfate+I-102, Rako-Binol+diammonium sulfate+I-102, Edenor+diammonium sulfate+I-102, Actirob B+diammonium sulfate+I-102, Mero+diammonium sulfate+I-102, Hasten+diammonium sulfate+I-103, Rako-Binol+diammonium sulfate+I-103, Edenor+diammonium sulfate+I-103, Actirob B+diammonium sulfate+I-103, Mero+diammonium sulfate+I-103, Hasten+diammonium sulfate+I-104, Rako-Binol+diammonium sulfate+I-104, Edenor+diammonium sulfate+I-104, Actirob B+diammonium sulfate+I-104, Mero+diammonium sulfate+I-104, Hasten+diammonium sulfate+I-105, Rako-Binol+diammonium sulfate+I-105, Edenor+diammonium sulfate+I-105, Actirob B+diammonium sulfate+I-105, Mero+diammonium sulfate+I-105, Hasten+diammonium sulfate+I-106, Rako-Binol+diammonium sulfate+I-106, Edenor+diammonium sulfate+I-106, Actirob B+diammonium sulfate+I-106, Mero+diammonium sulfate+I-106, Hasten+diammonium sulfate+I-107, Rako-Binol+diammonium sulfate+I-107, Edenor+diammonium sulfate+I-107, Actirob B+diammonium sulfate+I-107, Mero+diammonium sulfate+I-107, Hasten+diammonium sulfate+I-108, Rako-Binol+diammonium sulfate+I-108, Edenor+diammonium sulfate+I-108, Actirob B+diammonium sulfate+I-108, Mero+diammonium sulfate+I-108, Hasten+diammonium sulfate+I-109, Rako-Binol+diammonium sulfate+I-109, Edenor+diammonium sulfate+I-109, Actirob B+diammonium sulfate+I-109, Mero+diammonium sulfate+I-109, Hasten+diammonium sulfate+I-110, Rako-Binol+diammonium sulfate+I-110, Edenor+diammonium sulfate+I-110, Actirob B+diammonium sulfate+I-110, Mero+diammonium sulfate+I-110, Hasten+diammonium sulfate+I-111, Rako-Binol+diammonium sulfate+I-111, Edenor+diammonium sulfate+I-111, Actirob B+diammonium sulfate+I-111, Mero+diammonium sulfate+I-111, Hasten+diammonium sulfate+I-112, Rako-Binol+diammonium sulfate+I-112, Edenor+diammonium sulfate+I-112, Actirob B+diammonium sulfate+I-112, Mero+diammonium sulfate+I-112, Hasten+diammonium sulfate+I-113, Rako-Binol+diammonium sulfate+I-113, Edenor+diammonium sulfate+I-113, Actirob B+diammonium sulfate+I-113, Mero+diammonium sulfate+I-113, Hasten+diammonium sulfate+I-114, Rako-Binol+diammonium sulfate+I-114, Edenor+diammonium sulfate+I-114, Actirob B+diammonium sulfate+I-114, Mero+diammonium sulfate+I-114, Hasten+diammonium sulfate+I-115, Rako-Binol+diammonium sulfate+I-115, Edenor+diammonium sulfate+I-115, Actirob B+diammonium sulfate+I-115, Mero+diammonium sulfate+I-115, Hasten+diammonium sulfate+I-116, Rako-Binol-+diammonium sulfate+I-116, Edenor+diammonium sulfate+I-116, Actirob B+diammonium sulfate+I-116, Mero+diammonium sulfate+I-116, Hasten+diammonium sulfate+I-117, Rako-Binol+diammonium sulfate+I-117, Edenor+diammonium sulfate+I-117, Actirob B+diammonium sulfate+I-117, Mero+diammonium sulfate+I-117, Hasten+diammonium sulfate+I-118, Rako-Binol+diammonium sulfate+I-118, Edenor+diammonium sulfate+I-118, Actirob B+diammonium sulfate+I-118, Mero+diammonium sulfate+I-118, Hasten+diammonium sulfate+I-119, Rako-Binol+diammonium sulfate+I-119, Edenor+diammonium sulfate+I-119, Actirob B+diammonium sulfate+I-119, Mero+diammonium sulfate+I-119, Hasten+diammonium sulfate+I-120, Rako-Binol+diammonium sulfate+I-120, Edenor+diammonium sulfate+I-120, Actirob B+diammonium sulfate+I-120, Mero+diammonium sulfate+I-120, Hasten+diammonium sulfate+I-121, Rako-Binol+diammonium sulfate+I-121, Edenor+diammonium sulfate+I-121, Actirob B+diammonium sulfate+I-121, Mero+diammonium sulfate+I-121, Hasten+diammonium sulfate+I-122, Rako-Binol+diammonium sulfate+I-122, Edenor+diammonium sulfate+I-122, Actirob B+diammonium sulfate+I-122, Mero+diammonium sulfate+I-122, Hasten+diammonium sulfate+I-123, Rako-Binol+diammonium sulfate+I-123, Edenor+diammonium sulfate+I-123, Actirob B+diammonium sulfate+I-123, Mero+diammonium sulfate+I-123, Hasten+diammonium sulfate+I-124, Rako-Binol+diammonium sulfate+I-124, Edenor+diammonium sulfate+I-124, Actirob B+diammonium sulfate+I-124, Mero+diammonium sulfate+I-124, Hasten+diammonium sulfate+I-125, Rako-Binol+diammonium sulfate+I-125, Edenor+diammonium sulfate+I-125, Actirob B+diammonium sulfate+I-125, Mero+diammonium sulfate+I-125, Hasten+diammonium sulfate+I-126, Rako-Binol+diammonium sulfate+I-126, Edenor+diammonium sulfate+I-126, Actirob B+diammonium sulfate+I-126, Mero+diammonium sulfate+I-126, Hasten+diammonium sulfate+I-127, Rako-Binol+diammonium sulfate+I-127, Edenor+diammonium sulfate+I-127, Actirob B+diammonium sulfate+I-127, Mero+diammonium sulfate+I-127, Hasten+diammonium sulfate+I-128, Rako-Binol+diammonium sulfate+I-128, Edenor+diammonium sulfate+I-128, Actirob B+diammonium sulfate+I-128, Mero+diammonium sulfate+I-128, Hasten+diammonium sulfate+I-129, Rako-Binol+diammonium sulfate+I-129, Edenor+diammonium sulfate+I-129, Actirob B+diammonium sulfate+I-129, Mero+diammonium sulfate+I-129, Hasten+diammonium sulfate+I-130, Rako-Binol+diammonium sulfate+I-130, Edenor+diammonium sulfate+I-130, Actirob B+diammonium sulfate+I-130, Mero+diammonium sulfate+I-130, Hasten+diammonium sulfate+I-131, Rako-Binol+diammonium sulfate+I-131, Edenor+diammonium sulfate+I-131, Actirob B+diammonium sulfate+I-131, Mero+diammonium sulfate+I-131, Hasten+diammonium sulfate+I-132, Rako-Binol+diammonium sulfate+I-132, Edenor+diammonium sulfate+I-132, Actirob B+diammonium sulfate+I-132, Mero+diammonium sulfate+I-132, Hasten+diammonium sulfate+I-133, Rako-Binol+diammonium sulfate+I-133, Edenor+diammonium sulfate+I-133, Actirob B+diammonium sulfate+I-133, Mero+diammonium sulfate+I-133, Hasten+diammonium sulfate+I-134, Rako-Binol+diammonium sulfate+I-134, Edenor+diammonium sulfate+I-134, Actirob B+diammonium sulfate+I-134, Mero+diammonium sulfate+I-134, Hasten+diammonium sulfate+I-135, Rako-Binol+diammonium sulfate+I-135, Edenor+diammonium sulfate+I-135, Actirob B+diammonium sulfate+I-135, Mero+diammonium sulfate+I-135, Hasten+diammonium sulfate+I-136, Rako-Binol+diammonium sulfate+I-136, Edenor+diammonium sulfate+I-136, Actirob B+diammonium sulfate+I-136, Mero+diammonium sulfate+I-136, Hasten+diammonium sulfate+I-137, Rako-Binol+diammonium sulfate+I-137, Edenor+diammonium sulfate+I-137, Actirob B+diammonium sulfate+I-137, Mero+diammonium sulfate+I-137, Hasten+diammonium sulfate+I-138, Rako-Binol+diammonium sulfate+I-138, Edenor+diammonium sulfate+I-138, Actirob B+diammonium sulfate+I-138, Mero+diammonium sulfate+I-138, Hasten+diammonium sulfate+I-139, Rako-Binol+diammonium sulfate+I-139, Edenor+diammonium sulfate+I-139, Actirob B+diammonium sulfate+I-139, Mero+diammonium sulfate+I-139, Hasten+diammonium sulfate+I-140, Rako-Binol+diammonium sulfate+I-140, Edenor+diammonium sulfate+I-140, Actirob B+diammonium sulfate+I-140, Mero+diammonium sulfate+I-140, Hasten+diammonium sulfate+I-141, Rako-Binol+diammonium sulfate+I-141, Edenor+diammonium sulfate+I-141, Actirob B+diammonium sulfate+I-141, Mero+diammonium sulfate+I-141, Hasten+diammonium sulfate+I-142, Rako-Binol+diammonium sulfate+I-142, Edenor+diammonium sulfate+I-142, Actirob B+diammonium sulfate+I-142, Mero+diammonium sulfate+I-142, Hasten+diammonium sulfate+I-143, Rako-Binol+diammonium sulfate+I-143, Edenor+diammonium sulfate+I-143, Actirob B+diammonium sulfate+I-143, Mero+diammonium sulfate+I-143, Hasten+diammonium sulfate+I-144, Rako-Binol+diammonium sulfate+I-144, Edenor+diammonium sulfate+I-144, Actirob B+diammonium sulfate+I-144, Mero+diammonium sulfate+I-144, Hasten+diammonium sulfate+I-145, Rako-Binol+diammonium sulfate+I-145, Edenor+diammonium sulfate+I-145, Actirob B+diammonium sulfate+I-145, Mero+diammonium sulfate+I-145.

diammonium sulfate+I-1, diammonium sulfate+I-2, diammonium,sulfate+I-3,

diammonium sulfate+I-4, diammonium sulfate+I-5, diammonium sulfate+I-6,

diammonium sulfate+I-7, diammonium sulfate+I-8, diammonium sulfate+I-9,

diammonium sulfate+I-10, diammonium sulfate+I-11, diammonium sulfate+I-12,

diammonium sulfate+I-13, diammonium sulfate+I-14, diammonium sulfate+I-15,

diammonium sulfate+I-16, diammonium sulfate+I-17, diammonium sulfate+I-18,

diammonium sulfate+I-19, diammonium sulfate+I-20, diammonium sulfate+I-21,

diammonium sulfate+I-22, diammonium sulfate+I-23, diammonium sulfate+I-24,

diammonium sulfate+I-25, diammonium sulfate+I-26, diammonium sulfate+I-27,

diammonium sulfate+I-28, diammonium sulfate+I-29, diammonium sulfate+I-30,

diammonium sulfate+I-31, diammonium sulfate+I-32, diammonium sulfate+I-33,

diammonium sulfate+I-34, diammonium sulfate+I-35, diammonium sulfate+I-36,

diammonium sulfate+I-37, diammonium sulfate+I-38, diammonium sulfate+I-39,

diammonium sulfate+I-40, diammonium sulfate+I-41, diammonium sulfate+I-42,

diammonium sulfate+I-43, diammonium sulfate+I-44, diammonium sulfate+I-45,

diammonium sulfate+I-46, diammonium sulfate+I-47, diammonium sulfate+I-48,

diammonium sulfate+I-49, diammonium sulfate+I-50, diammonium sulfate+I-51,

diammonium sulfate+I-52, diammonium sulfate+I-53, diammonium sulfate+I-54,

diammonium sulfate+I-55, diammonium sulfate+I-56, diammonium sulfate+I-57,

diammonium sulfate+I-58, diammonium sulfate+I-59, diammonium sulfate+I-60,

diammonium sulfate+I-61, diammonium sulfate+I-62, diammonium sulfate+I-63,

diammonium sulfate+I-64, diammonium sulfate+I-65, diammonium sulfate+I-66,

diammonium sulfate+I-67, diammonium sulfate+I-68, diammonium sulfate+I-69,

diammonium sulfate+I-70, diammonium sulfate+I-71, diammonium sulfate+I-72,

diammonium sulfate+I-73, diammonium sulfate+I-74, diammonium sulfate+I-75,

diammonium sulfate+I-76, diammonium sulfate+I-77, diammonium sulfate+I-78,

diammonium sulfate+I-79, diammonium sulfate+I-80, diammonium sulfate+I-81,

diammonium sulfate+I-82, diammonium sulfate+I-83, diammonium sulfate+I-84,

diammonium sulfate+I-85, diammonium sulfate+I-86, diammonium sulfate+I-87,

diammonium sulfate+I-88, diammonium sulfate+I-89, diammonium sulfate+I-90,

diammonium sulfate+I-91, diammonium sulfate+I-92, diammonium sulfate+I-93,

diammonium sulfate+I-94, diammonium sulfate+I-95, diammonium sulfate+I-96,

diammonium sulfate+I-97, diammonium sulfate+I-98, diammonium sulfate+I-99,

diammonium sulfate+I-100, diammonium sulfate+I-101, diammonium sulfate+I-102, diammonium sulfate+I-103, diammonium sulfate++I-104, diammonium sulfate+I-105, diammonium sulfate+I-106, diammonium sulfate+I-107, diammonium sulfate+I-108, diammonium sulfate+I-109, diammonium sulfate+I-110,

diammonium sulfate+I-111, diammonium sulfate+I-112, diammonium sulfate+I-113, diammonium sulfate+I-114, diammonium sulfate+I-115, diammonium sulfate+I-116, diammonium sulfate+I-117, diammonium sulfate+I-118, diammonium sulfate+I-119, diammonium sulfate+I-120, diammonium sulfate+I-121,

diammonium sulfate+I-122, diammonium sulfate+I-123, diammonium sulfate+I-124, diammonium sulfate+I-125, diammonium sulfate+I-126, diammonium sulfate+I-127, diammonium sulfate+I-128, diammonium sulfate+I-129, diammonium sulfate+I-130, diammonium sulfate+I-131, diammonium sulfate+I-132,

diammonium sulfate+I-133, diammonium sulfate+I-134, diammonium sulfate+I-135, diammonium sulfate+I-136, diammonium sulfate+I-137, diammonium sulfate+I-138, diammonium sulfate+I-139, diammonium sulfate+I-140, diammonium sulfate+I-141, diammonium sulfate+I-142, diammonium sulfate+I-143,

diammonium sulfate+I-144, diammonium sulfate+I-145.

All of the combinations mentioned above may also comprise one or more safeners (c), in particular selected from the group consisting of (S1-1), (S1-6), (S1-9), (S2-1), (S3-1), (S-4) and/or one or more agrochemically active compounds (d), in particular selected from the groups (d1.1)-(d1.66), (d2.1)-(d2.50), (d3.1)-(d3.16), (d4.1)-(d4.7).

Furthermore, the combinations mentioned above may also comprise one or more sulfosuccinates e) and/or customary additives f) (in particular thickeners and thixotropic agents and/or inorganic salts).

For use, the herbicidal compositions according to the invention may, if appropriate, be diluted in a customary manner (for example using water), to give, for example, suspensions, emulsions, suspoemulsions, dispersions or solutions. It may be advantageous to add further agrochemically active compounds (for example tank mix partners in the form of corresponding formulations) and/or auxiliaries and additives customary for application, for example self-emulsifying oils, such as vegetable oils or paraffin oils, and/or fertilizers to spray emulsions which are obtained. Accordingly, the present invention also provides such herbicidal compositions.

The herbicidal compositions according to the invention and the use forms obtainable therefrom by dilution (all of which are referred to as “herbicidal compositions according to the invention”) have outstanding herbicidal activity against a broad spectrum of economically important monocotyledonous and dicotyledonous harmful plants, including species which are resistant to herbicidally active compounds such as glyphosate, glufosinate, atrazine or imidazolinone herbicides. The active compounds also act efficiently on perennial weeds which produce shoots from rhizomes, rootstocks or other perennial organs and which are difficult to control. The substances can be applied, for example, by the pre-sowing, the pre-emergence or the post-emergence method. Preferred is, for example, the application to the emerged harmful plants (for example weeds or unwanted crop plants), in particular prior to the emergence of the (wanted) crop plants.

Specific examples which may be mentioned are some representatives of the monocotyledonous and dicotyledonous weed flora which can be controlled by the compounds according to the invention, without the enumeration being a restriction to certain species.

The compositions act efficiently against, from amongst the monocotyledonous weed species, for example Avena spp., Alopecurus spp., Brachiaria spp., Digitaria spp., Lolium spp., Echinochloa spp., Panicum spp., Phalaris spp., Poa spp., Setaria spp. and also Cyperus species from the annual group and, from amongst the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp. Solanum spp., Stellaria spp., Veronica spp. and Viola spp., Xanthium spp., amongst the annuals, and Convolvulus, Cirsium, Rumex and Artemisia in the case of the perennial weeds.

If the herbicidal compositions according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the herbicidal compositions are applied post-emergence to the green parts of the plants, growth likewise stops drastically a very short time after the treatment and the weed plants remain at the growth stage at the point of time of application, or they die completely after a certain time, so that in this manner competition by the weeds, which is harmful to the crop plants, is eliminated at a very early point in time and in a sustained manner.

The herbicidal compositions according to the invention are distinguished by a rapidly commencing and long-lasting herbicidal action. As a rule, the rainfastness of the active compounds in the combinations according to the invention is advantageous. A particular advantage is that the dosages of the compounds, which are used in the combinations (a) and are effective, can be adjusted to such a low quantity that their soil action is optimally low. Not only does this allow them to be employed in sensitive crops in the first place, but groundwater contaminations are also virtually avoided. The active compound combinations according to the invention allow the application rate of the active compounds required to be reduced considerably.

The abovementioned properties and advantages are of benefit for weed control practice to keep agricultural crops free from undesired competing plants and thus to safeguard and/or increase the yields from the qualitative and quantitative point of view. These novel combinations markedly exceed the technical state of the art with a view to the properties described.

In addition, some of the compositions according to the invention have outstanding growth-regulatory properties in crop plants. They engage in the plant's metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without destroying the plants at the same time. Inhibition of vegetative growth is very important in a large number of monocotyledonous and dicotyledonous crops since yield losses caused by lodging can thus be reduced, or prevented completely.

By virtue of their herbicidal and plant-growth-regulatory properties, the compositions can be employed for controlling harmful plants in known crop plants or still to be developed tolerant or genetically modified crop plants. These transgenic plants are distinguished as a rule by particular, advantageous properties, such as, in addition to resistances to compositions according to the invention, for example resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:
the modification, by recombinant technology, of crop plants with the aim of modifying the starch synthesized in the plants (for example WO 92/11376, WO 92114827, WO 91/19806),
transgenic crop plants which exhibit resistances to other herbicides, for example to sulfonylureas (EP-A-0257993, U.S. Pat. No. 5,013,659),
transgenic crop plants with the capability of producing Bacillus thuringiensis toxins (Bt toxins), which make the plants resistant to certain pests (EP-A-0142924, EP-A-0193259),
transgenic crop plants with a modified fatty acid composition (WO 91/13972).

A large number of techniques in molecular biology are known in principle with the aid of which novel transgenic plants with modified properties can be generated; see, for example, Sambrook et al., 1989, Molecular Cloning, A Laboratory Manual, 2^{nd} Edition, Cold Spring Harbor Laboratory Press, Cold Spring Harbor, N.Y.; or Winnacker “Gene und Klone”, VCH Weinheim 2^{nd} Edition 1996 or Christou, “Trends in Plant Science” 1 (1996) 423-431).

To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribosome which specifically cleaves transcripts of the above mentioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

Thus, the present invention furthermore provides a method for controlling unwanted plants, preferably in crop plants, which comprises applying the herbicidal compositions according to the invention to the plants (for example harmful plants, such as monocotyledonous or dicotyledonous weeds or unwanted crop plants), the seed or the area on which the plants grow (for example the area under cultivation).

Unwanted plants are to be understood as meaning all plants which grow in locations where they are unwanted. This can, for example, be harmful plants (for example monocotyledonous or dicotyledonous weeds or unwanted crop plants), including, for example, those which are resistant to certain herbicidally active compounds, such as glyphosate, atrazine, glufosinate or imidazolinone herbicides.

In the process according to the invention, an effective amount of the herbicidal compositions according to the invention is preferably employed for controlling harmful plants, preferably in crop plants, for example in economically important farm crops, for example monocotyledonous farm crops, for example cereals (for example wheat, barley, rye, oats), rice, corn, millet, or dicotyledonous farm crops, such as sugar beet, oilseed rape, cotton, sunflowers and leguminous plants, for example of the genera Glycine (for example, Glycine max. such as non-transgenic Glycine max. (for example conventional cultivars, such as STS cultivars) or transgenic Glycine max. (for example RR-soybean or LL-soybean) and crossbreeds thereof, Phaseolus, Pisum, Vicia and Arachis, or vegetable crops from various botanical groups, such as potato, leek, cabbage, carrot, tomato, onion, and also permanent crops and plantation crops, such as pome fruit and stone fruit, berry fruit, grapevine, Hevea, bananas, sugar cane, coffee, tea, citrus fruits, nut plantations, lawn, palm plantations and forest plantations.

The herbicidal compositions according to the invention have excellent selectivity in crops of leguminous plants. They are suitable, for example, for the selective control of unwanted vegetation, for example of harmful plants (for example monocotyledonous and dicotyledonous weeds or unwanted crop plants) in crops of transgenic and nontransgenic leguminous plants, in particular of the genus Glycine, for example by the pre-sowing method, the pre-emergence method or the post-emergence method.

Suitable leguminous plants are, for example, transgenic and nontransgenic leguminous plants, for example of the genus Glycine, Phaseolus, Pisum, Vicia and Arachis. Preferred are leguminous plants of the genus Glycine, for example of the species Glycine max. (Soja), such as nontransgenic Glycine max. (for example conventional cultivars, such as STS cultivars) or transgenic Glycine max. (for example RR-soybeans or LL-soybeans) and crossbreeds thereof.

The herbicidal compositions according to the invention can also be employed non-selectively for controlling unwanted vegetation, for example in permanent crops and plantation crops, on roadsides, squares, industrial plants, airports or railway tracks, or for the burn-down application, for example in crop plants such as farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR-soybean or LL-soybean) and crossbreeds thereof), Phaseolus, Pisum, Vicia and Arachis, or vegetable crops from various botanical groups, such as potato, leek, cabbage, carrot, tomato, onion. The application is preferably carried out to the emerged harmful plants (for example weeds or unwanted crop plants), in particular prior to the emergence of (wanted) crop plants.

Permanent crops and plantation crops are, for example, pome fruit and stone fruit, berry fruit, grapevines, Hevea, bananas, sugarcane, coffee, tea, citrus fruit, nut plantations, roses, palm plantations and forest plantations.

Preferred for the non-selective application is the burn-down application in crop plants, the herbicidal compositions being applied to the emerged harmful plants prior to the emergence of the crop plants, application prior to or during sowing of the crop plants thereby being preferred.

The invention also provides the use of the herbicidal compositions according to the invention for controlling unwanted vegetation, preferably in crop plants.

To control unwanted vegetation (for example for the non-selective control of harmful plants or for the selective control of harmful plants in leguminous plants), the herbicidal compositions according to the invention can be applied to the plants (for example (wanted) crop plants or harmful plants, such as monocotyledonous or dicotyledonous weeds or unwanted crop plants), the seed (for example grains, seeds or vegetative propagation organs, such as tubers or shoot parts with buds) or to the area on which the plants grow (for example the area under cultivation), in particular in a herbicidally effective amount. They can be applied, for example, prior to sowing, and also both before and after emergence of the plants. Pre-sowing application can be carried out, for example, by spraying or incorporation into the soil. Split applications, for example early pre-emergence followed by later post-emergence application, are also possible. Preference is given to application to the emerged harmful plants (for example monocotyledonous or dicotyledonous weeds or unwanted crop plants), in particular prior to the emergence of (wanted) crop plants, such as leguminous plants.

For the selective use in leguminous plants, application to emerged plants, in particular to emerged harmful plants (for example weeds or unwanted crop plants) is preferred, preferably prior to the emergence of the leguminous plants. Preferred for the non-selective use is the application to the emerged harmful plants (for example weeds or unwanted crop plants). In the burn-down application, application is preferably carried out prior to sowing or during sowing of the crop plants, to the emerged harmful plants.

The amount of active compound applied may vary within a relatively wide range. It depends essentially on the nature of the desired effect. In general, the application rates are between 0.01 g and 100 g of active compound per hectare of soil surface. For selective use, preference is generally given to lower application rates, for example in the range from 0.01 g to 9 g of active compound per hectare, preferably between 0.1 g and 9 g per hectare, in particular in the application to emerged plants, in particular to emerged harmful plants (for example weeds or unwanted crop plants). Preferred for the non-selective use are generally application rates in the range from 0.01 g to 49 g of active compound per hectare, in particular from. 0.01 g to 9 g of active compound per hectare, preferably between 0.01 g and 9 g per hectare.

The herbicidal compositions of the present invention have excellent physical stability, are easy to apply and user friendly and have high biological effectiveness and crop plant compatibility (selectivity).

1. A herbicidal composition comprising a synergistically effective amount of
a) one or more herbicidally active dioxazinepyridylsulfonylurea compounds, and
b) one or more auxiliaries selected from the group consisting of fatty esters, fertilizers and surfactants.

2. The herbicidal composition as claimed in claim 1 which comprises, as component a),
one or more herbicidally active dioxazinepyridylsulfonylurea compounds of the formula (I) and/or salts thereof 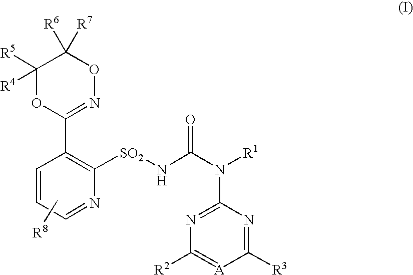
in which
A is nitrogen or a CR¹¹ grouping,
where
R¹¹ is hydrogen, alkyl, halogen or haloalkyl,
R¹ is hydrogen or an optionally substituted radical from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
where in the radicals mentioned above the alkyl and alkylene groups may each contain 1 to 6 carbon atoms, the alkenyl and alkynyl groups may each contain 2 to 6 carbon atoms, the cycloalkyl groups may each contain 3 to 6 carbon atoms and the aryl groups may each contain 6 or 10 carbon atoms.

3. The herbicidal composition as claimed in claim 1 which comprises, as component b), one or more fatty esters of natural origin.

4. The herbicidal composition as claimed in claim 1 which comprises, as component b), urea and/or ammonium salts.

5. The herbicidal composition as claimed in claim 1 which comprises, as component b), one or more nonionic surfactants.

6. The herbicidal composition as claimed in claim 1, additionally comprising c) one or more safeners, optionally selected from the group consisting of dichlorophenylpyrazoline-3-carboxylic acid and its esters, 5,5-diphenyl-2-isoxazoline-3-carboxylic acid and its esters and 8-quinolineoxyacetic acid and its esters, d) one or more agrochemically active compounds different from a) and c), e) one or more sulfosuccinates, optionally selected from the group consisting of the mono- and diesters of sulfosuccinic acid and/or f) customary additives, optionally selected from the group consisting of the thickeners and/or inorganic salts.

7. The herbicidal composition as claimed in claim 1 or 6, additionally comprising diluents.

8. A process for preparing a herbicidal composition as claimed in claim 1 or 7, which comprises mixing and, optionally grinding the components.

9. A method for controlling unwanted plants which comprises applying the components of the herbicidal composition as defined in claim 1 or 7 jointly or separately to the plants, a seed or an area on which plants grow.

10. (canceled)
